(19) United States
(12) Patent Application Publication
(10) Pub. No.: US 2018/0239410 A1
(43) Pub. Date: Aug. 23, 2018

(54) UNIVERSAL SERIAL BUS POWER DELIVERY (USB PD)-BASED BATTERY CHARGING

(71) Applicant: QUALCOMM Incorporated, San Diego, CA (US)

(72) Inventors: Georgios Konstantinos PAPARRIZOS, Foster City, CA (US); Christian SPORCK, Campbell, CA (US); Varaprasad ARIKATLA, San Jose, CA (US); Cheong KUN, San Diego, CA (US)

(21) Appl. No.: 15/898,055

(22) Filed: Feb. 15, 2018

Related U.S. Application Data
(60) Provisional application No. 62/460,604, filed on Feb. 17, 2017.

(51) Int. Cl. G06F 1/26; G06F 13/42; G06F 9/445

(52) U.S. Cl. CPC G06F 1/266; G06F 2213/0042; G06F 9/44505; G06F 13/4282

(57) ABSTRACT

Certain aspects of the present disclosure generally relate to methods and apparatus for charging a device. Some example methods for charging a device generally include providing power from a first device to a second device, the second device being configured for electrical connection with the first device via a cable. For example, a method may include transmitting a signal comprising one or more parameters associated with the first device to the second device, receiving a signal at the first device via a pin designated for a configuration channel, the signal indicating at least one of a requested charging voltage or a requested charging current based on the one or more parameters, and outputting power from the first device to the second device based on the signal.

### CLAIM OF PRIORITY UNDER 35 U.S.C. § 119

The present Application for Patent claims benefit of U.S. Provisional Patent Application Ser. No. 62/460,604, filed Feb. 17, 2017, which is assigned to the assignee hereof and hereby expressly incorporated by reference herein.

### TECHNICAL FIELD

The present disclosure generally relates to power transfer and, more specifically, to Universal Serial Bus (USB) Power Delivery (PD)-based battery charging.

### BACKGROUND

As portable devices proliferate, keeping the devices charged is increasingly important and, in some cases, tedious. Some users may have multiple devices (e.g., a smartphone, a Bluetooth® headset, a reader, a laptop, and so on) all needing to be charged, many of which use different charging standards that are incompatible with one another. These devices may also have different charging and/or power requirements. Managing one or more of multiple charging standards, different power transfer requirements, or different charging requirements for multiple devices may be onerous, and some of the current charging standards and/or implementations may reduce the charging efficiency and safety of the charging process that the multiple devices are capable of.

For example, an increasing number and variety of electronic devices are powered via rechargeable batteries. Such devices include mobile phones, portable music players, laptop computers, tablet computers, computer peripheral devices, communication devices (e.g., Bluetooth® devices), digital cameras, hearing aids, medical implants, and the like. While battery technology has improved, battery-powered electronic devices increasingly demand and consume variable amounts of power. As such, these devices may constantly require recharging. Rechargeable devices are often charged via wired connections that employ cables or other similar connectors that are physically connected to a power supply such as a USB cable. Cables and similar connectors may sometimes be inconvenient or cumbersome and have other drawbacks. Accordingly, improvements may allow users to charge and/or power electronic devices with a single electrical connection, thus reducing the number of components involved for operation of the electronic devices and simplifying the use thereof.

Further, different electronic devices may have different shapes, sizes, and/or power specifications. There is flexibility in having different sizes and shapes in the components (e.g., magnetic coil, charging plate, etc.) that make up a wired power transmitter and/or a wired power receiver in terms of industrial design and support for a wide range of devices. Despite the many differences, in one or more cases the different electronic devices are each provided with a form of wired USB connection that may be used to charge the device.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description,” one will understand how the features of this disclosure provide advantages that include improved power charging and user experience.

Certain aspects of the present disclosure provide a method for providing power from a first device to a second device, the second device being configured for electrical connection with the first device via a cable. The method generally includes transmitting a signal comprising one or more parameters associated with the first device to the second device, receiving a signal at the first device via a pin designated for a configuration channel, the signal indicating at least one of a requested charging voltage or a requested charging current based on the one or more parameters, and outputting power from the first device to the second device based on the signal.

Certain aspects of the present disclosure provide a first device for providing power to a second device, the second device being configured for electrical connection with the first device via a cable. The first device generally includes at least one logic circuit configured to transmit a signal comprising one or more parameters associated with the first device to the second device, receive a signal via a pin designated for a configuration channel, the signal indicating at least one of a requested charging voltage or a requested charging current based on the one or more parameters, and a power supply configured to output power from the first device to the second device based on the signal.

Certain aspects of the present disclosure provide an apparatus for providing power from another apparatus, the apparatus being configured for electrical connection with the other apparatus via a cable. The apparatus generally includes means for transmitting a signal comprising one or more parameters associated with the first device to the second device, means for receiving a signal via a pin designated for a configuration channel based on the one or more parameters, the signal indicating at least one of a requested charging voltage or a requested charging current, and means for outputting power from the apparatus to the other apparatus based on the signal.

Certain aspects of the present disclosure provide a non-transitory computer-readable medium having instructions stored thereon for providing power from a first device to a second device, the second device being configured for electrical connection with the first device via a cable. The instructions generally include transmitting a signal comprising one or more parameters associated with the first device to the second device, receiving a signal at the first device via a pin designated for a configuration channel based on the one or more parameters, the signal indicating at least one of a requested charging voltage or a requested charging current, and outputting power from the first device to the second device based on the signal.

Certain aspects of the present disclosure provide a method for receiving power from a first device at a second device, the second device being configured for electrical connection with the first device via a cable. The method generally includes receiving a signal comprising one or more parameters associated with the first device at the second device, transmitting a signal from the second device to the first device via a pin designated for a configuration channel, the signal indicating at least one of a requested charging voltage or a requested charging current based on the one or more parameters, and receiving power from the first device at the second device based on the at least one of the requested charging voltage or the requested charging current.

Certain aspects of the present disclosure provide a first device capable of electrical connection with a second device via a cable. The first device generally includes a logic circuit configured to receive a signal comprising one or more parameters associated with the second device, transmit a signal to the second device via a pin designated for a configuration channel, the signal indicating at least one of a requested charging voltage or a requested charging current based on the one or more parameters, and a charging port configured to receive power from the second device based on the at least one of the requested charging voltage or the requested charging current.

Certain aspects of the present disclosure provide an apparatus for receiving power from another apparatus, the apparatus being configured for electrical connection with the other apparatus via a cable. The apparatus generally includes means for receiving a signal comprising one or more parameters associated with the first device at the second device, means for transmitting a signal to the other apparatus via a pin designated for a configuration channel, the signal indicating at least one of a requested charging voltage or a requested charging current based on the one or more parameters, and means for receiving power from the other apparatus based on the at least one of the requested charging voltage or the requested charging current.

Certain aspects of the present disclosure provide a non-transitory computer-readable medium having instructions stored thereon for receiving power from a first device at a second device, the second device being configured for electrical connection with the first device via a cable. The instructions generally include receiving a signal comprising one or more parameters associated with the first device at the second device, transmitting a signal from the second device to the first device via a pin designated for a configuration channel, the signal indicating at least one of a requested charging voltage or a requested charging current based on the one or more parameters, and receiving power from the first device at the second device based on the at least one of the requested charging voltage or the requested charging current.

Certain aspects of the present disclosure provide a method for providing power from a first device to a second device, the second device being configured for electrical connection with the first device via a cable. The method generally includes sensing a temperature associated with the first device, determining that the temperature is above a threshold, and transmitting a signal from the first device to the second device based on determining that the temperature is above the threshold.

Certain aspects of the present disclosure provide a first device capable of electrical connection with a second device via a cable. The first device generally includes at least one sensor configured to sense a temperature associated with the first device, and at least one logic circuit configured to determine that the temperature is above a threshold and to transmit a signal from the first device to the second device based on the temperature being above the threshold.

Certain aspects of the present disclosure provide an apparatus for providing power to another apparatus, the apparatus being configured for electrical connection with the other apparatus via a cable. The apparatus generally includes means for sensing a temperature associated with the apparatus, means for determining that the temperature is above a threshold, and means for transmitting a signal from the apparatus to the other apparatus based on determining that the temperature is above the threshold.

Certain aspects of the present disclosure provide a non-transitory computer-readable medium having instructions stored thereon for providing power from a first device to a second device, the second device being configured for electrical connection with the first device via a cable. The instructions generally include sensing a temperature associated with the first device, determining that the temperature is above a threshold, and transmitting a signal from the first device to the second device based on determining that the temperature is above the threshold.

Certain aspects of the present disclosure provide a method for receiving power from a first device at a second device, the second device being configured for electrical connection with the first device via a cable. The method generally includes receiving an alert signal at the second device from the first device, the alert signal being based on a temperature associated with the first device being above a threshold, and taking an action at the second device, based on the alert signal.

Certain aspects of the present disclosure provide a first device capable of electrical connection with a second device via a cable. The first device generally includes at least one logic circuit configured to receive an alert signal from the second device, the alert signal being based on a temperature associated with the second device being above at least one threshold, and configured to take an action based on the alert signal.

Certain aspects of the present disclosure provide an apparatus for receiving power from another apparatus, the apparatus being configured for electrical connection with the other apparatus via a cable. The apparatus generally includes means for receiving an alert signal from the other apparatus, the alert signal being based on a temperature associated with the other apparatus being above a threshold, and means for taking an action at the apparatus, based on the alert signal.

Certain aspects of the present disclosure provide a non-transitory computer-readable medium having instructions stored thereon for receiving power from a first device at a second device, the second device being configured for electrical connection with the first device via a cable. The instructions generally include receiving an alert signal at the second device from the first device, the alert signal being based on a temperature associated with the first device being above a threshold, and taking an action at the second device, based on the alert signal.

Certain aspects of the present disclosure provide a method for providing power from a first device to a second device, the second device being configured for electrical connection with the first device via a cable. The method generally includes receiving a query at the first device from the second device whether the first device is configured to support dynamic adjustment of a charging voltage with a resolution of 20 mV or smaller, and transmitting a response from the first device to the second device, in response to the query.

Certain aspects of the present disclosure provide a first device capable of electrical connection with a second device via a cable. The apparatus generally includes at least one logic circuit configured to receive a query from the second device whether the first device is configured to support dynamic adjustment of a charging voltage with a resolution of 20 mV or smaller, and to transmit a response from the first device to the second device, in response to the query.

Certain aspects of the present disclosure provide an apparatus for providing power to another apparatus, the apparatus being configured for electrical connection with the other apparatus via a cable. The apparatus generally includes means for receiving a query from the other apparatus whether the apparatus is configured to support dynamic adjustment of a charging voltage with a resolution of 20 mV or smaller, and means for transmitting a response to the other apparatus, in response to the query.

Certain aspects of the present disclosure provide a non-transitory computer-readable medium having instructions stored thereon for providing power from a first device to a second device, the second device being configured for electrical connection with the first device via a cable. The instructions generally include receiving a query at the first device from the second device whether the first device is configured to support dynamic adjustment of a charging voltage with a resolution of 20 mV or smaller, and transmitting a response from the first device to the second device, in response to the query.

Certain aspects of the present disclosure provide a method for receiving power from a first device at a second device, the second device being configured for electrical connection with the first device via a cable. The method generally includes transmitting, from the second device to the first device, a query whether the first device is configured to support dynamic adjustment of a charging voltage with a resolution of 20 mV or smaller; and receiving, at the second device, a response from the first device in response to the query.

Certain aspects of the present disclosure provide a first device capable of electrical connection with a second device via a cable. The first device generally includes a logic circuit configured to transmit, to the second device, a query whether the second device is configured to support dynamic adjustment of a charging voltage with a resolution of 20 mV or smaller, and receive a response from the second device in response to the query.

Certain aspects of the present disclosure provide an apparatus for receiving power from another apparatus, the apparatus being configured for electrical connection with the other apparatus via a cable. The apparatus generally includes means for transmitting, to the other apparatus, a query whether the other apparatus is configured to support dynamic adjustment of a charging voltage with a resolution of 20 mV or smaller; and means for receiving a response from the other apparatus in response to the query.

Certain aspects of the present disclosure provide a non-transitory computer-readable medium having instructions stored thereon for receiving power from a first device at a second device, the second device being configured for electrical connection with the first device via a cable. The instructions generally include transmitting, from the second device to the first device, a query whether the first device is configured to support dynamic adjustment of a charging voltage with a resolution of 20 mV or smaller; and receiving, at the second device, a response from the first device in response to the query.

Certain aspects of the present disclosure provide a method for receiving power from a first device at a second device, the second device being configured for electrical connection with the first device via a cable. The method generally includes receiving power from the first device at the second device; receiving, at the second device, an indication from the first device that a third device is connected with the first device; and transmitting, from the second device to the first device, a signal for adjusting at least one of a requested charging voltage or a requested charging current, based on the indication.

Certain aspects of the present disclosure provide a first device capable of electrical connection with a second device via a cable. The first device generally includes at least one logic circuit configured to receive power from the second device, to receive an indication from the second device that a third device is connected with the second device, and transmit, to the second device, a signal for adjusting at least one of a requested charging voltage or a requested charging current, based on the indication.

Certain aspects of the present disclosure provide a first apparatus for receiving power from a second apparatus, the first apparatus being configured for electrical connection with the second apparatus via a cable. The first apparatus generally includes means for receiving power from the second apparatus; means for receiving an indication from the second apparatus that a third apparatus is connected with the second apparatus; and means for transmitting, from the first apparatus to the second apparatus, a signal for adjusting at least one of a requested charging voltage or a requested charging current, based on the indication.

Certain aspects of the present disclosure provide a non-transitory computer-readable medium having instructions stored thereon for receiving power from a first device at a second device, the second device being configured for electrical connection with the first device via a cable. The instructions generally include receiving power from the first device at the second device; receiving, at the second device, an indication from the first device that a third device is connected with the first device; and transmitting, from the second device to the first device, a signal for adjusting at least one of a requested charging voltage and/or a requested charging current, based on the indication.

Certain aspects of the present disclosure provide a method for providing power from a first device to a second device, the second device being configured for electrical connection with the first device via a cable. The method generally includes outputting power from the first device, measuring a voltage of the power that is output at the first device, and transmitting, from the first device to the second device, a signal indicative of the voltage.

Certain aspects of the present disclosure provide a first device capable of electrical connection with a second device via a cable. The first device generally includes a power supply configured to output power, a sensor configured to measure a voltage of the power that is output at the first device, and at least one logic circuit configured to transmit, from the first device to the second device, a signal indicative of the voltage.

Certain aspects of the present disclosure provide an apparatus for providing power to another apparatus, the apparatus being configured for electrical connection with the other apparatus via a cable. The apparatus generally includes means for outputting power, means for measuring a voltage of the power that is output at the apparatus, and means for transmitting, from the apparatus to the other apparatus, a signal indicative of the voltage.

Certain aspects of the present disclosure provide a non-transitory computer-readable medium having instructions stored thereon for providing power from a first device to a second device, the second device being configured for electrical connection with the first device via a cable. The instructions generally include outputting power from the first device, measuring a voltage of the power that is output at the first device, and transmitting, from the first device to the second device, a signal indicative of the voltage.

Certain aspects of the present disclosure provide a method for receiving power from a first device at a second device, the second device being configured for electrical connection with the first device via a cable. The method generally includes receiving power at the second device from the first device, receiving a signal indicative of a first voltage of power as measured at the first device, measuring a second voltage of the power at the second device, and calculating a resistance of the cable based on a difference between the first voltage and the second voltage and/or other components on this path.

Certain aspects of the present disclosure provide a first device capable of electrical connection with a second device via a cable. The first device generally includes at least one logic circuit configured to receive power from the second device and to receive a signal indicative of a first voltage of power as measured at the second device, and a sensor configured to measure a second voltage of the power at the first device, the at least one logic circuit being further configured to calculate a resistance of the cable based on a difference between the first voltage and the second voltage.

Certain aspects of the present disclosure provide an apparatus for receiving power from another apparatus, the apparatus being configured for electrical connection with the other apparatus via a cable. The apparatus generally includes means for receiving power from the other apparatus, means for receiving a signal indicative of a first voltage of power as measured at the other apparatus, means for measuring a second voltage of the power at the apparatus, and means for calculating a resistance of the cable based on a difference between the first voltage and the second voltage.

Certain aspects of the present disclosure provide a non-transitory computer-readable medium having instructions stored thereon for receiving power from a first device at a second device, the second device being configured for electrical connection with the first device via a cable. The instructions generally include receiving power at the second device from the first device, receiving a signal indicative of a first voltage of power as measured at the first device, measuring a second voltage of the power at the second device, and calculating a resistance of the cable based on a difference between the first voltage and the second voltage.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how aspects in accordance with the present disclosure may be practiced. In the accompanying drawings:

FIG. 1 is a functional block diagram of an example power transfer system, in accordance with certain aspects of the present disclosure.

FIG. 2 illustrates an example environment in which techniques for charging devices may be implemented.

FIG. 3 illustrates example implementations that are operable to utilize charger-device techniques, in accordance with certain aspects of the present disclosure.

FIG. 4 is a flow diagram of example operations for providing power from a first device to a second device, in accordance with certain aspects of the present disclosure.

FIG. 4A is a block diagram illustrating example means capable of performing the operations shown in FIG. 4.

FIG. 5 is a flow diagram of example operations for receiving power from a first device at a second device, in accordance with certain aspects of the present disclosure.

FIG. 5A is a block diagram illustrating example means capable of performing the operations shown in FIG. 5.

FIG. 6 is a flow diagram of example operations for providing power from a first device to a second device, in accordance with certain aspects of the present disclosure.

FIG. 6A is a block diagram illustrating example means capable of performing the operations shown in FIG. 6.

FIG. 7 is a flow diagram of example operations for receiving power from a first device at a second device, in accordance with certain aspects of the present disclosure.

FIG. 7A is a block diagram illustrating example means capable of performing the operations shown in FIG. 7.

FIG. 8 is a flow diagram of example operations for providing power from a first device to a second device, in accordance with certain aspects of the present disclosure.

FIG. 8A is a block diagram illustrating example means capable of performing the operations shown in FIG. 8.

FIG. 9 is a flow diagram of example operations for receiving power from a first device at a second device, in accordance with certain aspects of the present disclosure.

FIG. 9A is a block diagram illustrating example means capable of performing the operations shown in FIG. 9.

FIG. 10 is a flow diagram of example operations for receiving power from a first device at a second device, in accordance with certain aspects of the present disclosure.

FIG. 10A is a block diagram illustrating example means capable of performing the operations shown in FIG. 10.

FIG. 11 is a flow diagram of example operations for providing power from a first device to a second device, in accordance with certain aspects of the present disclosure.

FIG. 11A is a block diagram illustrating example means capable of performing the operations shown in FIG. 11.

FIG. 12 is a flow diagram of example operations for receiving power from a first device at a second device, in accordance with certain aspects of the present disclosure.

FIG. 12A is a block diagram illustrating example means capable of performing the operations shown in FIG. 12.

FIG. 13 is a flow diagram of example operations for implementing temperature monitoring, in accordance with certain aspects of the present disclosure.

FIG. 14 is a diagram of charging shown over time based on temperature monitoring, in accordance with certain aspects of the present disclosure.

FIG. 15 is a diagram of charging shown over time based on temperature monitoring of a USB connector, in accordance with certain aspects of the present disclosure.

To facilitate understanding, identical reference numerals have been used, where possible, to designate identical elements that are common to the figures. It is contemplated that elements described in one aspect may be beneficially utilized on other aspects without specific recitation. Aspects generally include methods, apparatus, systems, computer program products, computer-readable medium, and processing systems, as substantially described herein with reference to and as illustrated by the accompanying drawings.

### DETAILED DESCRIPTION

The Universal Serial Bus (USB) Power Delivery (PD) specification is a widely adopted specification by the mobile industry and, in accordance with one or more aspects as discussed in the following disclosure, its communication protocol may be used to bring more intelligence to the power source and power sink. Further, in addition to new features that may be implemented, some other technology features implemented as part of other charge technology and power management integrated circuits (PMICs) may also be redefined and applied in USB PD. These features may allow for fast and efficient (and consistent) battery charging, as well as adaptive charging in USB PD-based systems. Furthermore, one or more of these features may increase safety by defining specific monitoring functions and algorithms.

Aspects of the present disclosure provide apparatus, methods, processing systems, and computer-readable media for devices and chargers that may be connected using a data and power connection, such as a USB connection, that provides both communication and charging functionality. A specific example of this may include, but is not limited to, a USB PD which may provide both a primary source of power along with a data interface. For example, many devices may charge and/or get their power from a USB port that is provided on any number of devices. Particularly, a USB port has become a ubiquitous power socket for many small devices such as cell phones and other hand-held devices.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein.

In addition, the scope of the disclosure is intended to cover such an apparatus or method which is practiced using other structure, functionality, or structure and functionality in addition to or other than the various aspects of the disclosure set forth herein. It should be understood that any aspect of the disclosure described herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

### Example Power Transfer Systems and Charging Environments

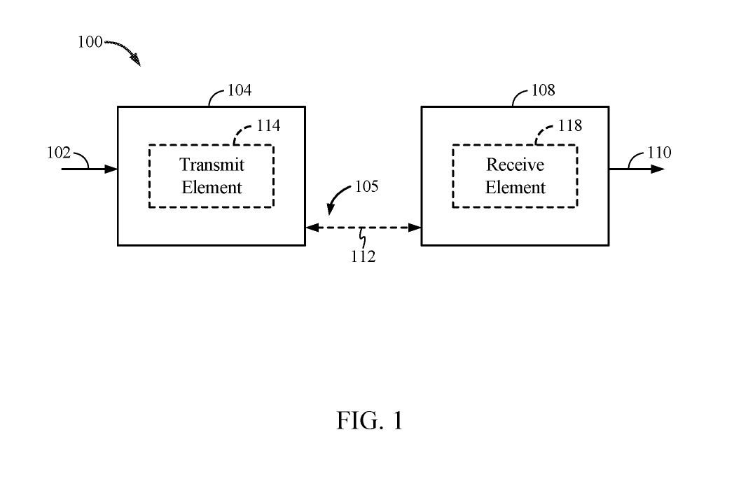

FIG. 1 is a functional block diagram of an example power transfer system 100, in accordance with certain aspects of the present disclosure. Input power 102 may be provided to a transmitter 104 from a power source (not shown in this figure) to generate a power transmittance 105 for performing energy transfer. A receiver 108 may be subjected to the power transmittance 105 and generate output power 110 for storing or consumption by a device (not shown in this figure) coupled to the output power 110. The transmitter 104 and the receiver 108 may be separated by a distance 112 along which the power transmittance 105 is transmitted using a power cable, such as a USB PD cable. In other cases, the cable may include pogo pins, and in some cases the power transmittance may be implemented using connector-less connections. The transmitter 104 may include a power transmitting element 114 for transmitting/providing energy to the receiver 108. The receiver 108 may include a power receiving element 118 for receiving/capturing energy transmitted from the transmitter 104.

In accordance with one or more aspects, the transmitter 104 and receiver 108 in certain cases may be able to change roles, and therefore, power transfer may change directions. An example is a power bank which may receive power from a device to be charged or may provide power for the device to charge.

In certain aspects, the power transmittance 105 may also carry an information signal nested in the power transmittance 105. The power transmittance 105 may correspond to a frequency region in which there may be low and/or consistent noise signatures resulting from the currents and charges in the power transmitting element 114 that radiate power away from the power transmitting element 114. The information signal may correspond to a region that may be within a select wavelength of the power transmitting element 114. Conversely, the information signal may correspond to a region that used a number of wavelengths of the power transmitting element 114. In another example, the cable may include a number of different paths (also referred to as channels) and connection pins along which either power or an information signal may be transmitted. Accordingly, one or more pins/paths may be selected for data transfer while the other one or more pins may be selected for power transmittance 105.

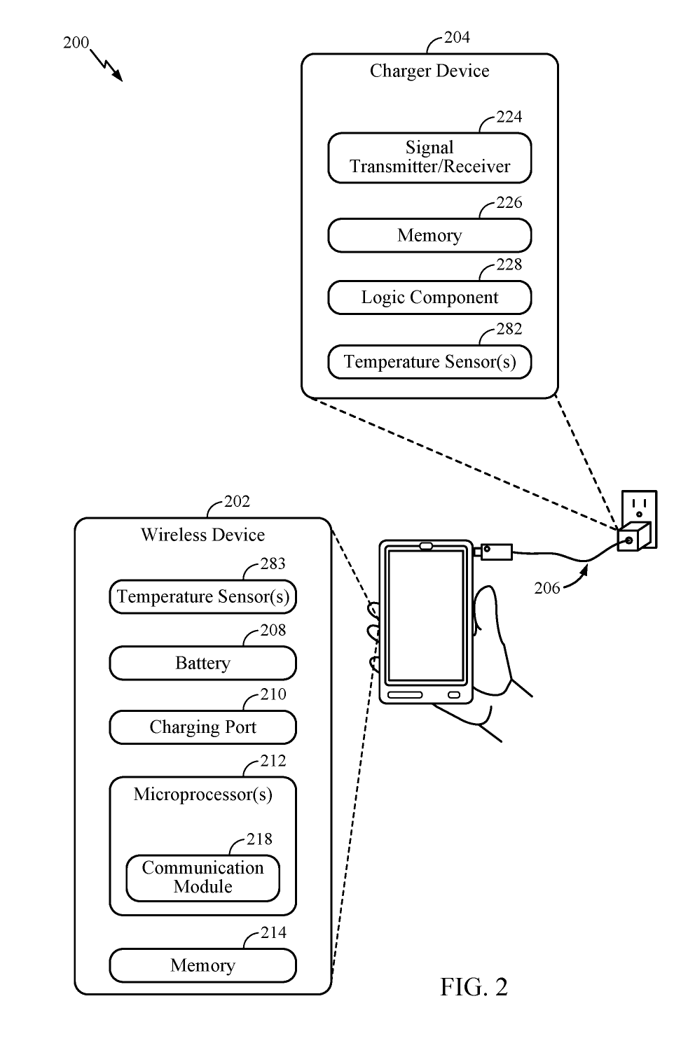

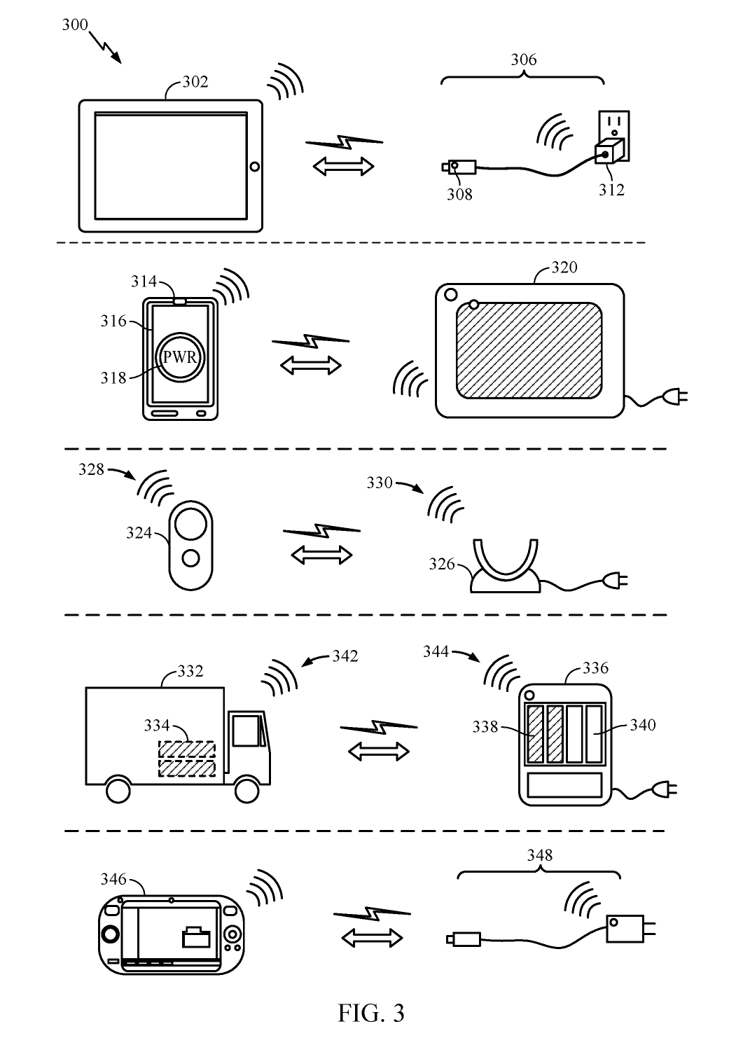

FIG. 2 illustrates an example environment 200 in which techniques for charger-device recharging may be implemented. For example, FIG. 2 illustrates a wireless device 202 communicatively coupled to a charger device 204 via a wired connection 206, such as a USB PD-compliant cable. The wireless device 202 may also be communicatively coupled to a charger device 204 using a wireless network connection, a near field wireless connection, some other data connection, or some combination thereof. The wireless device 202 is representative of a battery-powered electronic device having a battery 208 that may be rechargeable. Electronic devices that may be used to implement the wireless device 202 may be configured in a variety of ways as shown in FIG. 3. Electronic devices, for example, may be configured as a computing device (e.g., a laptop computer, a tablet, a smartphone, a mobile phone, a portable media player, a handheld gaming device, and so on). In addition, an electronic device may be configured as a battery-operated child's toy, a broadcast receiver (e.g., baby monitor), a two-way radio, a remote control, a wireless gaming controller, and so on. Certain devices may perform power transmit and receive functions.

The wireless device 202 and the charger device 204 may connect to a network that may assume a wide variety of configurations. For example, the network may include a wide area network (WAN), a local area network (LAN), a wireless network (WLAN), a wireless personal area network (WPAN) (e.g., Bluetooth®, Bluetooth® low energy (BLE), ZigBee®, and so on), a public telephone network, an intranet, and so on. Further, although a single network is one example, the network may be representative of multiple networks.

The wireless device 202 is illustrated as including a variety of hardware components, examples of which include a charging port 210, one or more microprocessors 212, and an example of a computer-readable storage medium illustrated as memory 214. The microprocessor 212 is representative of functionality to perform operations through execution of instructions stored in the memory 214. Although illustrated separately, functionality of these components may be further divided, combined (e.g., on an application specific integrated circuit (ASIC)), and so forth.

The charging port 210 is representative of a port (e.g., a USB type-C port) via which a connection may be made with the charger device 204 in order to receive power to charge the battery 208. The charging port 210 may include any of a variety of configurations. Examples include a Universal Serial Bus (USB) port (e.g., a charging downstream port (CDP) or a dedicated charging port (DCP)), a port for a 19 volt circular-connector, a connector-less port (pogo pins), a wireless charging “port,” and so on. Accordingly, any of a variety of different wired charging ports 210 may be utilized to interface with a charging connector of a charger device.

The microprocessor 212 is illustrated as including at least a communication module 218. The communication module 218 is representative of functionality to communicate with the charger device 204. In implementations, charging port 210 may include, for example, other modules such as another communication module, a control module, a sensor module, and other modules. The communication module 218 supports communication via the wired connection 206. When the battery 208 reaches a certain low-level of charge, the communication module 218 may transmit to the charger device 204 a request for the charger device 204 to alert a user that the battery 208 of the wireless device 202 needs charging and that the charger device 204 may be available to provide that charge. If the charger device 204 has previously been connected to the wireless device 202, the charger device 204 may easily receive that request and respond accordingly. The charging port 210 may be configured to both receive and/or provide control signal, data signal, and other signals relating to charging the battery 208 of the wireless device. The wireless device 202 and the charger device 204 may be connected and exchange a unique ID. Once connected, any of a variety of networks (e.g., IEEE 802.11, Bluetooth®, BLE, ZigBee®, and so on in addition to the USB data connection) may be used to communicate with the user regarding charging of the wireless device 202.

The charger device 204 is illustrated as including a signal transmitter/receiver 224 and a memory 226. The memory 226 may include short-term volatile memory and/or random access memory (RAM) to store variables. The memory 226 may be used to store connection information (e.g., unique ID) between the charger device 204 and the wireless device 202, system information about the charger device 204, and so on. In some cases, the charger device 204 may not include a memory. The signal transmitter/receiver 224 may transmit a message to the wireless device 202 to indicate that the request was received. Additional information may be included in that message, such as an indication that the charger device 204 is available for charging.

The charger device 204 is available for charging if, for instance, the charger device 204 is plugged in to a power source (e.g., outlet), and is not currently charging another device or battery. The charger device 204, however, may not be required to be plugged in to a power source to be available, such as in the case of a power bank, which is a portable device that can supply USB power using stored energy in its built-in batteries. Accordingly, it may be appreciated that a power bank may power a wireless device if the power bank is not connected to a power source and the power bank's own battery has capacity that may be used to charge the wireless device. In this case, the charger device 204 may be available if the charger device 204 is not currently charging another device or battery, and has fully charged the built-in batteries. In another example, the charger device 204 may be connected to a number of different devices that the charger device 204 is charging. In this case, the charger device 204, or one of the connected devices, may collect and generate power control information to determine how much power resources to assign to each device from the available charging resources of the charger device 204.

The charger device 204 is also illustrated as including a logic component 228. In implementations, the logic component 228 may include any of a variety of mechanisms capable of receiving, processing, generating, and/or transmitting power information signals. For instance, the logic component 228 may include one or more processors capable of collecting temperature data and then emitting different temperature information signals to the wireless device 202 based on the temperature data. In some cases, the logic component 228 may include a simple analog or digital chip. Alternatively or in addition, the logic component 228 may be capable of transmitting information about the current and/or voltage being provided to the wireless device 202. In at least one aspect, the charger device 204 may notify a user that the charger device 204 is available to charge the wireless device 202 by generating an alert. The alert may also indicate compatibility of the charger device 204 with the wireless device 202. Further, in certain aspects, the charger device 204 may incorporate features and functionality expected by the wireless device 202 in an effort to achieve optimum, or at least desired, charging operation. The alert or another signal may indicate such capabilities of the charger device 204 to the wireless device 202.

Because both the wireless device 202 and the charger device 204 generate data and/or control signals for controlling the charging, the wireless device 202 and/or the charger device 204 may influence the charging parameters to be implemented for the connected devices using the wired connection 206.

In implementations, the wireless device 202 may determine a variety of useful information. For instance, the wireless device 202 may determine the state of charge of the battery 208, temperature data at different monitored points in the system, and an availability of charge. The state of charge may be determined in any suitable way. For example, a sensor, such as a battery gauge, may be used to monitor a state of charge of the battery 208. When the state of charge reaches a certain level of charge (e.g., below a predefined or user-defined threshold), the microprocessor 212 determines that the battery is low.

In one or more cases, a temperature sensor 283 may be included in the wireless device 202. In another case, a temperature sensor 282 may be included in the charger device 204. Further, in one or more cases, a plurality of temperature sensors may be included at different internal and/or external positions at one or both of the wireless device 202 and charger device 204. These one or more temperature sensors may detect temperature values at one or more select locations in the wireless device 202 and/or charger device 204. These values may be provided to a processing device, such as the microprocessor 212 and/or the logic component 228, where the values may be compared to threshold temperatures values, for example. Further action may be taken based on the temperatures values, any subsequent processing, and the threshold comparisons.

For example, if any of the temperature values exceed a threshold value, the amount of power being provided may be adjusted to alleviate the temperature. Further, if the temperature readings are below thresholds, then the charger device may be instructed to increase the power being provided. Additionally, in another example multiple temperature sensors may be provided at, for example, different cells of a battery 208. In this example, a method may use these sensors to for determining which cells to switch on and off for charging based on the temperature of any given cell within the battery 208. Further, in another example, if the temperature value exceeds a different threshold, power transfer may be terminated. Accordingly, selective continuous charging may be implemented based on temperature sensor values collected and analyzed.

According to another example, one or more temperature sensors may be placed on an outer surface and configured to take an ambient temperature of the environment which may be compared to a threshold. If the ambient temperature exceeds the threshold, recommendations may be provided to a user through the use of different forms of alerts suggesting that the user move the device from its current position, such as moving the device out of direct sunlight or away from a hot surface or heat exhaust port of another device, such as a nearby laptop or desktop computer. Other examples of temperature-based power adjustments may also be included in accordance with one or more cases.

The availability of charge may be determined in a variety of ways. For example, if the charger device 204 is unplugged, then the charger device 204 is likely unavailable to charge. A battery-powered charger is likely not available if the charger has not completed charging itself. A battery recharger is likely not available if the recharger has not completed recharging a battery pack. If the charger device 204 is not available for charging, then the charger device 204 does not send a message to the wireless device to indicate availability, and does not generate an alert to notify the user. Instead, the charger device 204 may remain silent or non-responsive, which indicates that the charger device 204 may be unavailable. Otherwise, the charger device 204 may send the availability message if the charger device 204 is available for charging.

FIG. 3 illustrates example implementations 300 that are operable to utilize charger-device charging techniques in accordance with certain aspects of the present disclosure.

In at least one example, a tablet 302 may be capable of accepting a variety of different USB chargers, for example any version of Quick Charge (QC)-compliant chargers might be used in this example to provide suitable power and a fast charge and/or specific safety features. When the tablet 302 needs power, the tablet 302 may be connected to a wired connection 306 that includes a USB connector 308 and QC charger 312. The tablet 302 may then be connected with the QC charger 312, wherein the QC charger 312 may provide a requested power voltage/current as controlled by power logic that may be found in either the tablet or the charger.

Alternatively, a mobile phone 314 may include a display device 316 configured to display information 318 indicating one or more of, for example, that the mobile phone 314 needs charging, the status of the charging process, collected information about the temperature of the phone, cable, and/or charger, and/or control options for charging. A charger 320, may receive a message that the mobile phone 314 needs charging, and then indicate if the charger 320 is compatible with the mobile phone 314 and may be available to charge the mobile phone 314. Additionally, in certain aspects, the display device 316 may be used to provide display information 318 that includes an alert or other notification to a user of a number of device conditions, such as a hot adapter, an alert to a user of an unsafe component such as a cable, or an alert of a non-optimum component such as a cable.

In yet another example, a broadcast receiver, such as a baby monitor 324, may be connected to a USB charger cradle 326. Here, the baby monitor 324 may be required to be mounted on the charger cradle 326 for charging to occur. When the baby monitor 324 reaches a low state of charge, the baby monitor 324 may be connected to the cradle and implement a number of charging features as described below. The devices may continue to communicate and output signals while charging as indicated by signal transmittances 328 and 330.

In another example, a battery-operated toy truck 332 including rechargeable batteries 334, such as AA batteries, may be connected to a battery charger 336. When the batteries 334 of the toy truck 332 are low, and the toy truck 332 may be connected to the battery charger 336 using a USB connection, the toy truck 332 may send a message 342 to the battery charger 336 to indicate that the batteries 334 may be low along with other information such as temperature information and/or specific voltage and current requests based on any information received/collected by the toy truck 332. The battery charger 336 may send an acknowledgement 344 upon receiving the message 342 and may further include other information related to charging. Further, the battery charger 336 may include power sharing with an onboard battery charging feature 338. Both the toy truck 332 and the battery charger 336 may receive power from the battery charger 336 based on system information that may include, for example, temperatures of different components, voltage and current requests, etc. For example, if the battery charger 336 does not have fully charged batteries in the onboard battery charging feature 338, or only has empty slots 340, the battery charger 336 may adjust the power shared with the toy truck 332 accordingly based on the toy truck 332 power needs. The devices may continue to communicate and output signals while charging as indicated by signal transmittances 342 and 344.

Yet another example includes a portable media player 346 connected with a standard USB charger 348. When the portable media player 346 reaches a relatively low level of charge, both the portable media player 346 and the standard USB charger 348 may provide and receive information allowing one or both to generate control signals to determine charging of the portable media player 346. In another example, when multiple devices need charge, each device and the charger may use a particular power sharing method that allows matching a device to a correct charger power that the charger is able to provide, taking into account different device charging capabilities, device power needs, and temperatures.

Further, in accordance with one or more cases as described above, the charging device and device being charged may be able to switch roles such that power may be provided in the other direction, from the device previously being charged to the original charging device, through the presence of a power bank in one or both devices. In other cases, the charging device and device being charged may both receive and transmit power concurrently.

### Example Charging Based on Voltage and Current Negotiation Using a Channel

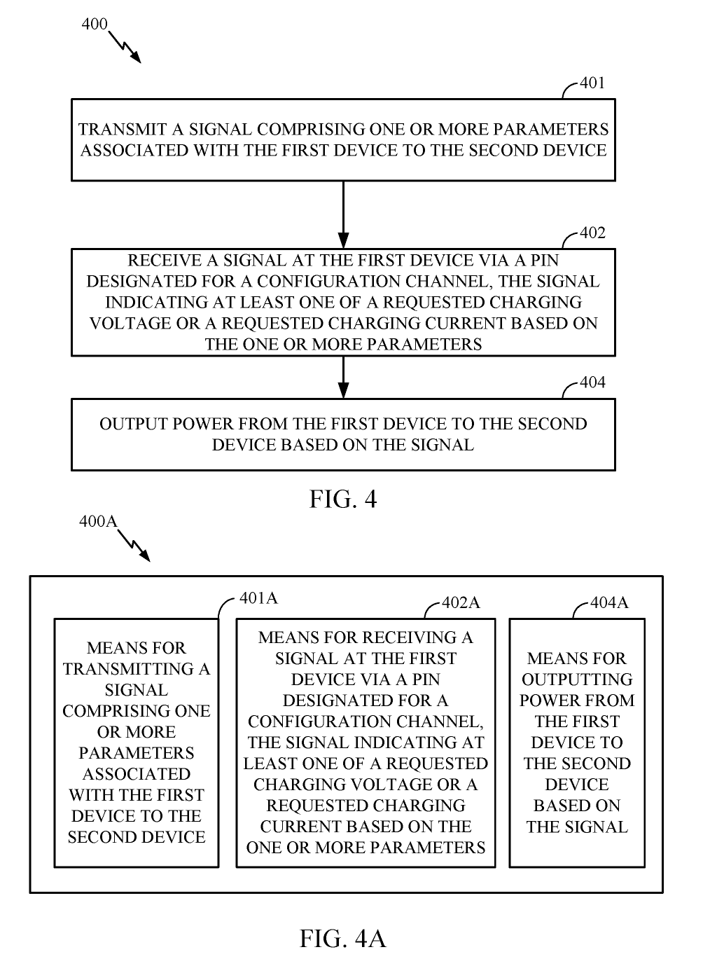

FIG. 4 is a flow diagram of example operations 400 for providing power and/or a requested charging current from a first device to a second device, where the second device may be configured for electrical connection with the first device using a cable, in accordance with certain aspects of the present disclosure. The operations 400 may be performed, for example, by the first device, which may be a charger (e.g., charger device 204) and may also be called a power adapter. The second device may perform a power-management algorithm that may generate the requested charging voltage or requested charging current. An example of this may include implementing an Intelligent Negotiation for Optimum Voltage (INOV) which is a power-management algorithm and may use a pin designated for a configuration channel.

The operations 400 may begin, at block 401, with transmitting a signal comprising one or more parameters associated with the first device to the second device. The operations 400 may further include, at block 402, receiving a signal at the first device via a pin designated for a configuration channel, the received signal indicating at least one of a requested charging voltage or a requested charging current based on the one or more parameters. Additionally, operations 400 may further provide, at block 404, outputting power from the first device to the second device based on the received signal.

For certain aspects, the first device may include a universal serial bus (USB) type-C port comprising the pin designated for the configuration channel. According to one or more cases, the configuration channel may be a universal serial bus (USB) power delivery (PD) configuration channel 1 (CC1) or configuration channel 2 (CC2). In other cases, the configuration channel may be configured to support other connector types and one or more other data communication standards, such as Thunderbolt. Further, in one or more cases, the first device includes a power adapter.

FIG. 4A is a block diagram of a device 400A that may include various means-plus-function components configured to perform the operations 400 illustrated in FIG. 4. For example, at block 401A, the device 400A includes means for performing the operations illustrated at block 401 in FIG. 4. Further, at block 402A, the device 400A includes means for performing the operations illustrated at block 402 in FIG. 4. Additionally, at block 404A, the device 400A includes means for performing the operations illustrated at block 404 in FIG. 4. For example, means for performing the operations as illustrated at blocks 402 and 404 of FIG. 4 may include a charger device 204 as shown in FIG. 2. Further, the means for performing the operations may specifically include one or more of a temperature sensor 282, a logic component 228, a memory 226, and a signal transmitter/receiver 224.

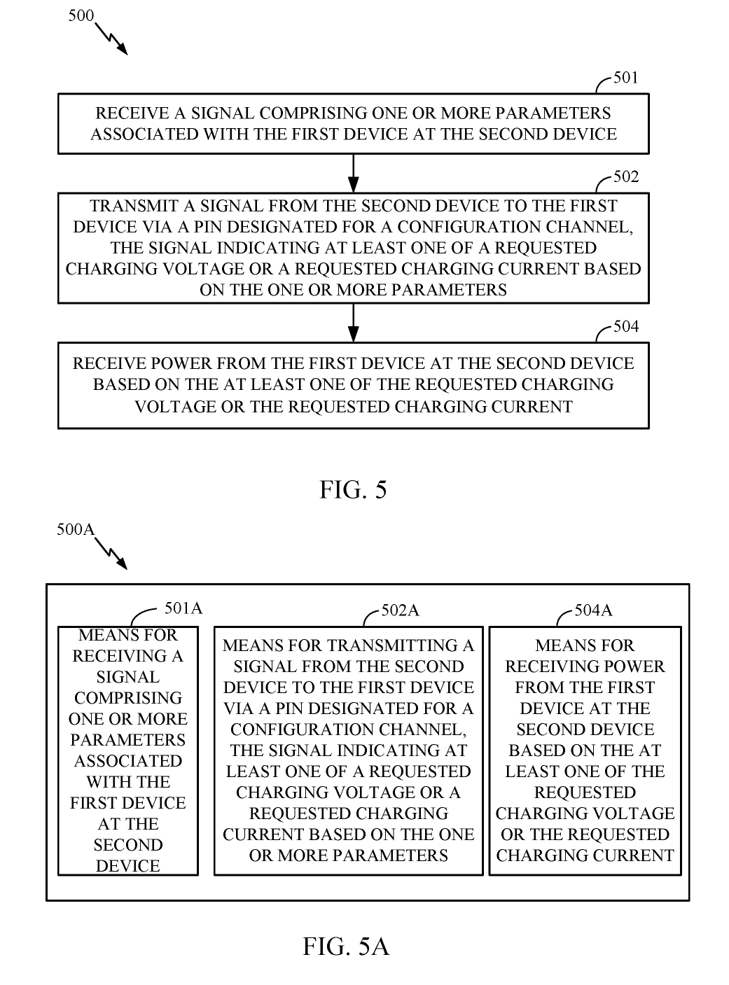

FIG. 5 is a flow diagram of example operations 500 for receiving power and/or a requested charging current from a first device at a second device, the second device being configured for electrical connection with the first device via a cable, in accordance with certain aspects of the present disclosure. The operations 500 may be performed by the second device, which may be a wireless device (wireless device 202), such as a cellular phone.

The operations 500 may begin, at block 501, with receiving a signal comprising one or more parameters associated with the first device at the second device. The operations 500 may further include, at block 502, transmitting a signal from the second device to the first device via a pin designated for a configuration channel, the transmitted signal indicating at least one of a requested charging voltage or a requested charging current based on the one or more parameters. The operations 500 also include, at block 504, receiving power from the first device at the second device based on the at least one of the requested charging voltage or the requested charging current.

According to one or more aspects, the second device may include a universal serial bus (USB) type-C port that includes the pin designated for the configuration channel. In one or more cases, the configuration channel may be a universal serial bus (USB) power delivery (PD) configuration channel 1 (CC1) or configuration channel 2 (CC2). The operations 500 may further include determining the at least one of the requested charging voltage and/or the requested charging current based on one or more parameters associated with at least one of the first device or the second device. The second device may include a battery, and the one or more parameters may include a state of charge of the battery. The one or more parameters may include at least one of one or more thermal signals associated with the first device, a load on the first device, or a charge power for the second device. The determining may include determining the requested charging voltage with a resolution of 20 mV or less.

For example, in one or more cases, Intelligent Negotiation of Optimum Voltage (INOV) may be provided via either of the CC1/CC2 channels, depending on which is in use. This selection may depend on which way the USB connector is connected to the device. This INOV functionality may be used in conjunction with the USB PD communication and algorithm to allow better voltage resolution such as, for example, 20 mV for USB PD or even lower for other applications. Further, in accordance with other aspects, the INOV functionality and algorithm may be used to provide other aspects and functionality beyond thermal support and voltage resolution. For example, in one or more cases, the specific voltage and/or current levels may be determined based on one or more of a temperature, system load, battery state of charge (SOC), charge load, and other properties or any combination thereof.

FIG. 5A is a block diagram of a device 500A that may include various means-plus-function components configured to perform the operations 500 illustrated in FIG. 5. For example, at block 501A, the device 500A includes means for performing the operations illustrated at block 501 in FIG. 5. Additionally, at block 502A, the device 500A includes means for performing the operations illustrated at block 502 in FIG. 5. Further, at block 504A, the device 500A includes means for performing the operations illustrated at block 504 in FIG. 5. For example, means for performing the operations as illustrated at blocks 502 and 504 of FIG. 5 may include a wireless device 202 as shown in FIG. 2. Further, the means for performing the operations may specifically include one or more of a temperature sensor 208, a battery 208, a charging port 210, a microprocessor 212, a communication module 218, and a memory 214.

### Example Charging Based on Monitoring Temperature

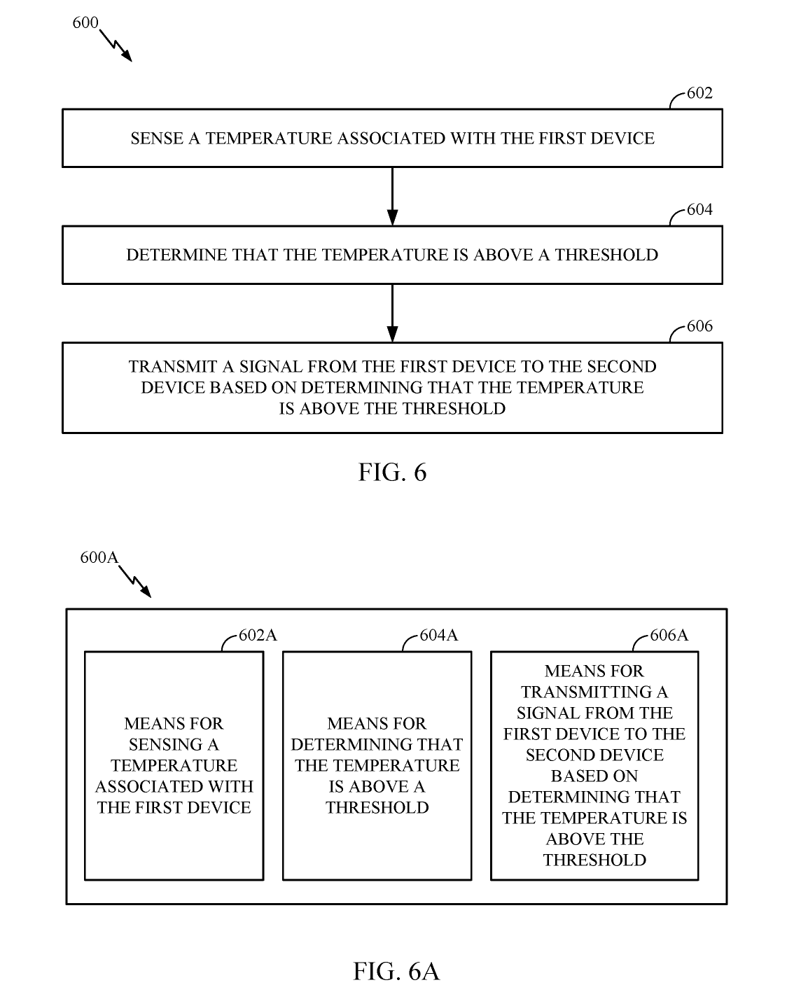

FIG. 6 is a flow diagram of example operations 600 for providing power from a first device to a second device, in accordance with certain aspects of the present disclosure. For example, the operations 600 may include temperature monitoring from the perspective of an adapter/charger.

The operations 600 may begin, at block 602, with sensing a temperature associated with the first device. The first device, or adapter, may further include, at block 604, determining that the sensed temperature is above a threshold. Additionally, the method may include, as shown at block 606, transmitting a signal from the first device to the second device based on the determination.

According to one or more aspects, the operations 600 may further include outputting power from the first device, wherein the temperature is sensed while the first device is outputting the power. In one or more cases, the transmitting may include transmitting the signal via a pin designated for a configuration channel. The first device may include a universal serial bus (USB) type-C port including the pin designated for the configuration channel. Further, the configuration channel may be a universal serial bus (USB) power delivery (PD) configuration channel 1 (CC1) or configuration channel 2 (CC2). According to one or more aspects, the signal may include at least one of a warning flag, a shutdown flag, or a thermal regulation flag.

In one or more cases, the first device may include a housing element and the temperature associated with the first device may include a temperature of the housing. The first device may further include an interface for connecting the cable, and the temperature associated with the first device may include a temperature of the interface. Further, in one or more cases, the temperature associated with the first device may include an ambient temperature adjacent the first device. The method may further include sensing another temperature associated with the first device, determining that the other sensed temperature is above another threshold, and transmitting another signal from the first device to the second device based on the determination of the other sensed temperature being above the other threshold.

Additionally, in accordance with one or more aspects, the operations 600 may include sensing one or more temperature values that include at least one or more of a case temperature, an ambient temperature, a critical temperature location, an adapter board temperature, and/or receiving the one or more temperature values at the second device. According to one or more cases, the first device may be or include a power adapter.

FIG. 6A is a block diagram of a device 600A that may include various means-plus-function components configured to perform the operations 600 illustrated in FIG. 6. For example, at block 602A, the device 600A includes means for performing the operations illustrated at block 602 in FIG. 6. Additionally, at block 604A, the device 600A includes means for performing the operations illustrated at block 604 in FIG. 6. Further, at block 606A, the device 600A includes means for performing the operations illustrated at block 606 in FIG. 6. For example, means for performing the operations as illustrated at blocks 602, 604, and 606 of FIG. 6 may include a wireless device 202 as shown in FIG. 2. Further, the means for performing the operations may specifically include one or more of a temperature sensor 208, a battery 208, a charging port 210, a microprocessor 212, a communication module 218, and a memory 214.

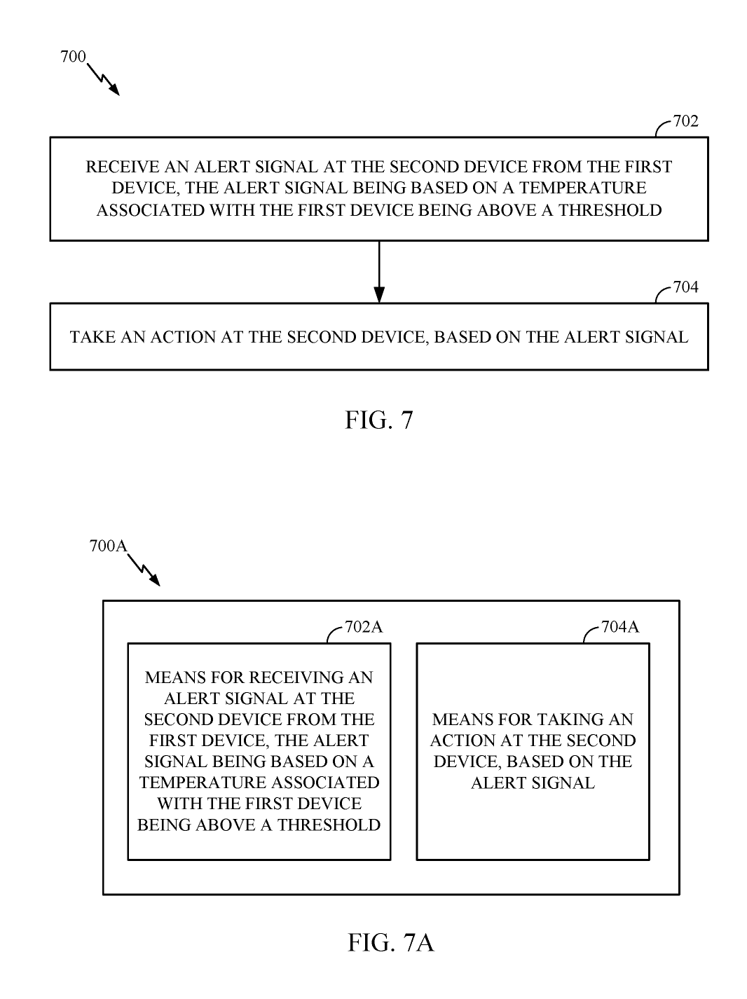

FIG. 7 is a flow diagram of example operations 700 for receiving power from a first device at a second device, the second device being configured for electrical connection with the first device via a cable, in accordance with certain aspects of the present disclosure. An example of which may include temperature monitoring from the perspective of a device that requires charging, such as a cellular phone or other wireless device.

The operations 700 may begin, at block 702, with receiving an alert signal at the second device from the first device, the alert signal being based on a temperature associated with the first device being above one or more thresholds. The operations 700 further include, at block 704, taking an action at the second device, based on the received alert signal.

According to one or more aspects, the operations 700 may further include receiving power at the second device from the first device, where the alert signal may be received while the second device is receiving the power. The action may include providing a notification at a user interface (UI) of the second device. In another case, the action may include transmitting a control signal from the second device to the first device. The control signal may include a shutdown signal for shutting down the first device. In another case, the control signal may include a power configuration signal for reducing at least one of a voltage or a current requested by the second device. The control signal and/or the power configuration signal may be further based on one or more of a battery state, thermal signals, system load, charger power, other system parameters, or a combination thereof.

According to one or more cases, the transmitting may further include transmitting the control signal via a pin designated for a configuration channel. In one or more cases, the first device may include a universal serial bus (USB) type-C port comprising the pin designated for the configuration channel. The configuration channel may be a universal serial bus (USB) power delivery (PD) configuration channel 1 (CC1) or configuration channel 2 (CC2). Further, in one or more cases, the alert signal may include at least one of a warning flag, a shutdown flag, or a thermal regulation flag.

For example, in a monitoring case, ambient and/or connector temperature of an accessory (source) may be detected and the accessory may communicate various signals/states to a wireless device that is being charged (sink) about the monitored temperature. Particularly, some examples of signals/states that may be communicated include but are not limited to over-temperature warning flag for each of the thermal monitors, over-temperature shut down flag for each of the thermal monitors, and over-temperature thermal regulation flag for each of the thermal monitors.

FIG. 7A is a block diagram of a device 700A that may include various means-plus-function components configured to perform the operations 700 illustrated in FIG. 7. For example, at block 702A, the device 700A includes means for performing the operations illustrated at block 702 in FIG. 7. Additionally, at block 704A, the device 700A includes means for performing the operations illustrated at block 704 in FIG. 7. For example, means for performing the operations as illustrated at blocks 702 and 704 of FIG. 7 may include a charger device 204 as shown in FIG. 2. Further, the means for performing the operations may specifically include one or more of a temperature sensor 282, a logic component 228, a memory 226, and a signal transmitter/receiver 224.

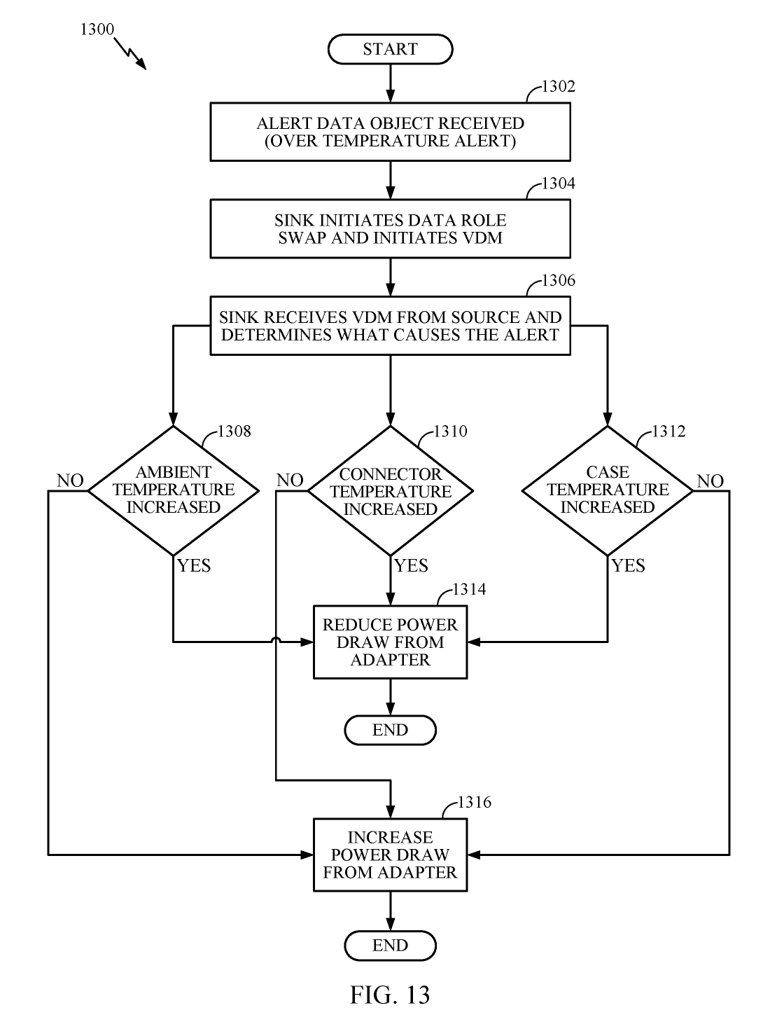

Another example is shown in FIG. 13 which includes a flowchart depicting a specific example of a method for implementing temperature monitoring in accordance with one or more aspects. Specifically, FIG. 13 includes operations 1300 that provide temperature monitoring. The operations 1300 include, at block 1302, alerting that a data object is received over a temperature alert. The operations 1300 also include, at block 1304, the sink initiating data role swap and initiating a vendor-defined message (VDM). Further, operations 1300 include, at block 1306, the sink receiving a VDM from the source and determining what caused the alert. At block 1308 is shown the case when ambient temperature is increased. At block 1310 is shown the case when connector temperature is increased. Further, at block 1312 is shown the case when case temperature is increased. If any of the temperatures increase, then the operations 1300 go on to show that, at block 1314, a reduction in power draw from the adapter may be implemented. In some cases, this reduction in power draw from the adapter may suspend power from the adapter all together. Alternatively, in block 1316, if no temperatures are detected as increasing, then an increase in power draw from the adapter may be implemented.

In such an example, the alert may be generated whenever there is a change in state. Further, when an over temperature change in state is determined, the method may include probing the VDMs to see which caused the over temperature event. Accordingly, if the over temperature event is due to hitting a higher threshold on temperature, the power draw from the adapter may be reduced.

In accordance with one or more cases, once such information is available to the sink, the sink may also take specific actions to mitigate the situation. For example, some actions the sink may be able to implement include, but are not limited to, reducing voltage and/or current, shutting down the adapter, informing a system (UI, user) about potential issues, and other operations or combinations thereof.

In certain aspects, during normal operation the first device may be configured to communicate with the second device and take actions based on those communications as discussed above. However, under certain cases, the first device may autonomously take certain actions when configured to if the second device is “off” and/or not communicating.

### Example Identification of Devices for Charging

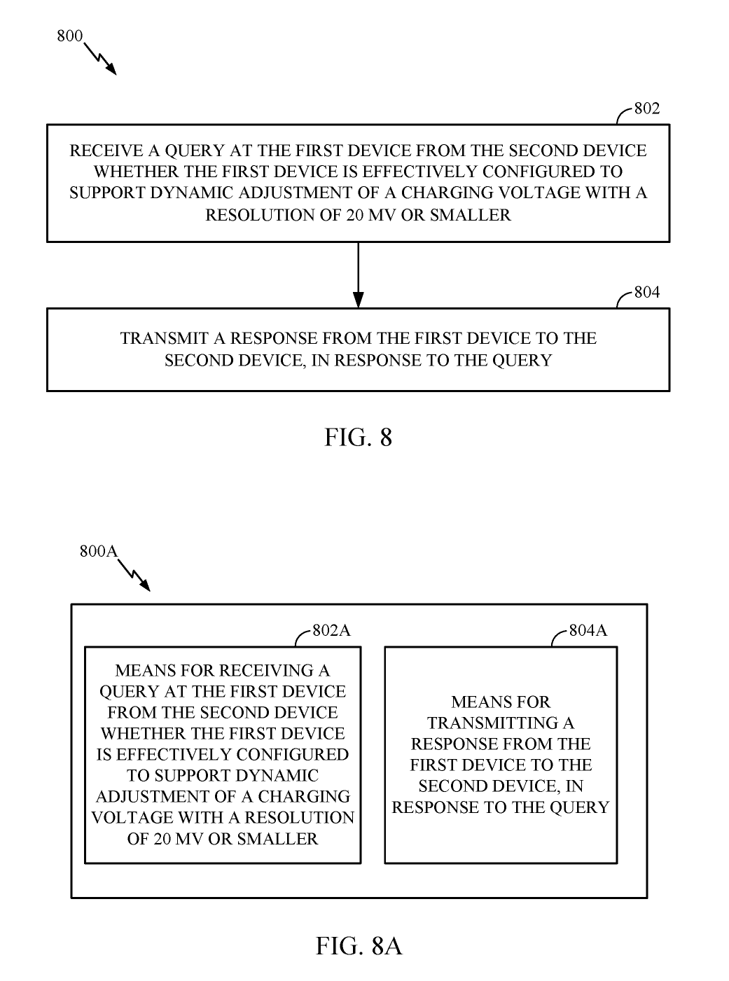

FIG. 8 is a flow diagram of example operations 800 for providing power from a first device to a second device, the second device being configured for electrical connection with the first device via a cable, in accordance with certain aspects of the present disclosure. An example of which may include identification of a compliant adapter from the perspective of the adapter.

The operations 800 may begin, at block 802, with receiving a query at the first device from the second device whether the first device is configured to support dynamic adjustment of a charging voltage with a resolution of 20 mV or smaller or dynamic adjustment of current with a high resolution such as, for example, 100 mA or better. The operations 800 may further include, at block 804, transmitting a response from the first device to the second device, in response to the received query.

In accordance with one or more aspects, a vendor-defined message (VDM) may be provided. For example, in Quick Charge 4, a VDM may be used to determine that the Power Source is QC4. Further, in one or more cases specific identities may be defined based on VDMs. In one or more cases, other messaging may also be included beyond VDMs. In accordance with some cases, the query may be configured for determining if an adapter supports higher voltage resolution, which may not be part of VDM.

In one or more cases, the receiving may further include receiving the query via a pin designated for a configuration channel. The first device may include a universal serial bus (USB) type-C port comprising the pin designated for the configuration channel. The configuration channel may be a universal serial bus (USB) power delivery (PD) configuration channel 1 (CC1) or configuration channel 2 (CC2). The query may be configured to query whether the first device may be configured to support dynamic power adjustment in compliance with a universal serial bus (USB) power delivery (PD) standard. The query may be further configured to query whether the first device may be configured to support at least one of one or more thermal monitors or one or more particular power profiles. The query may further include whether the first device supports one or more of multiple thermal monitors, power profiles, and any combination thereof. In one or more cases, the first device may be or includes a power adapter.

FIG. 8A is a block diagram of a device 800A that may include various means-plus-function components configured to perform the operations 800 illustrated in FIG. 8. For example, at block 802A, the device 800A includes means for performing the operations illustrated at block 802 in FIG. 8. Additionally, at block 804A, the device 800A includes means for performing the operations illustrated at block 804 in FIG. 8. For example, means for performing the operations as illustrated at blocks 802 and 804 of FIG. 8 may include a charger device 204 as shown in FIG. 2. Further, the means for performing the operations may specifically include one or more of a temperature sensor 282, a logic component 228, a memory 226, and a signal transmitter/receiver 224.

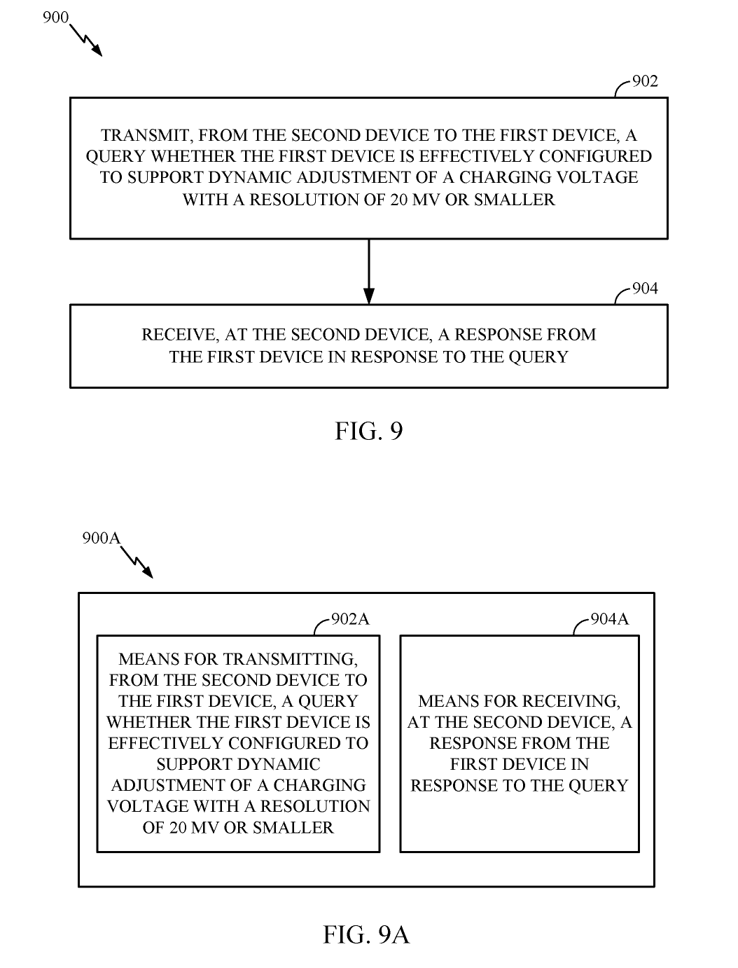

FIG. 9 is a flow diagram of example operations 900 for receiving power from a first device at a second device, the second device being configured for electrical connection with the first device via a cable, in accordance with certain aspects of the present disclosure. An example of which may include identification of a compliant adapter from the perspective of a wireless device, such as a phone.

The operations 900 may begin, at block 902, by transmitting, from the second device to the first device, a query whether the first device is configured to support dynamic adjustment of a charging voltage with a resolution of 20 mV or smaller. In one or more cases, the device may be configured to support dynamic adjustment of a charging current with a resolution of 100 mA or less. The operations 900 may also include, at block 904, receiving, at the second device, a response from the first device in response to the received query.

According to one or more aspects, the operations 900 may further include transmitting a signal from the second device to the first device, wherein the transmitted signal indicates at least one of a requested charging voltage or a requested charging current. The operations 900 may further include receiving power from the first device at the second device based on the at least one of the requested charging voltage or the requested charging current. Further, according to another aspect, the transmitting may include transmitting the query via a pin designated for a configuration channel. The second device may include a universal serial bus (USB) type-C port comprising the pin designated for the configuration channel. The configuration channel may be a universal serial bus (USB) power delivery (PD) configuration channel 1 (CC1) or configuration channel 2 (CC2). In one or more cases, the query may be configured to query whether the first device is configured to support dynamic power adjustment in compliance with a universal serial bus (USB) power delivery (PD) standard.

For example, one or more cases may include identification and authentication of a source supporting Quick Charge Technology for a sink to run the corresponding charging algorithms.

In one or more cases, the method may include receiving a query at the first device from the second device whether the first device is configured for supporting other configurations expected by the second device, such as specific thermal monitoring and response, an exact output voltage indication, specific power profiles, and/or other characteristics of the first device.

FIG. 9A is a block diagram of a device 900A that may include various means-plus-function components configured to perform the operations 900 illustrated in FIG. 9. For example, at block 902A, the device 900A includes means for performing the operations illustrated at block 902 in FIG. 9. Additionally, at block 904A, the device 900A includes means for performing the operations illustrated at block 904 in FIG. 9. For example, means for performing the operations as illustrated at blocks 902 and 904 of FIG. 9 may include a wireless device 202 as shown in FIG. 2. Further, the means for performing the operations may specifically include one or more of a temperature sensor 208, a battery 208, a charging port 210, a microprocessor 212, a communication module 218, and a memory 214.

### Example Power Sharing When Charging Multiple Devices

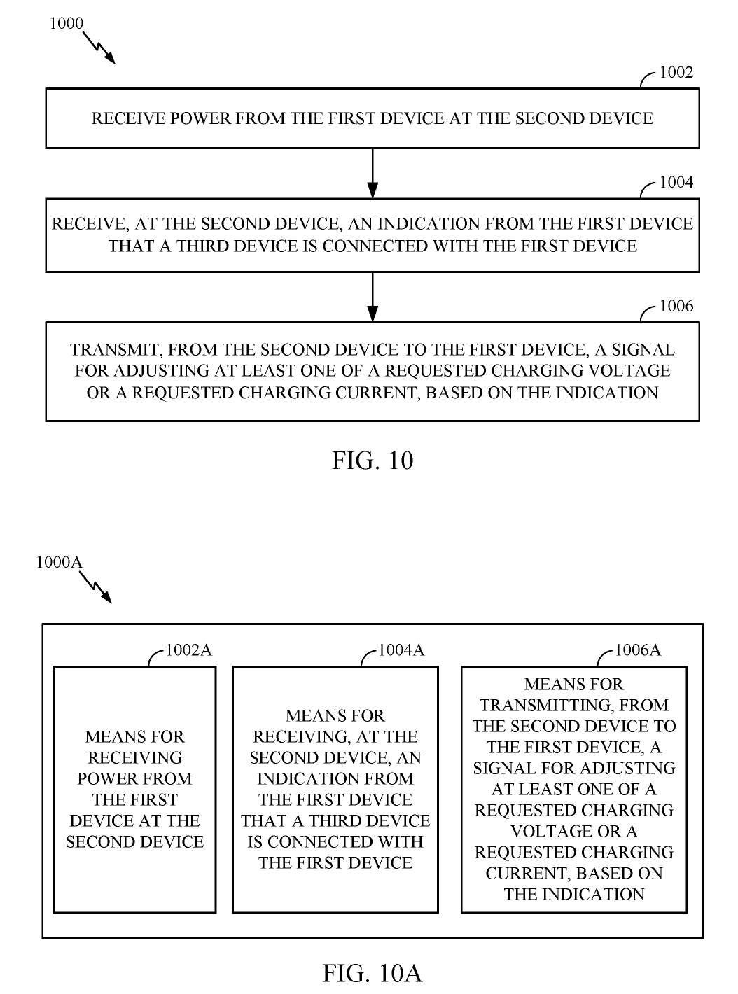

FIG. 10 is a flow diagram of example operations 1000 for receiving power from a first device at a second device, the second device being configured for electrical connection with the first device via a cable, in accordance with certain aspects of the present disclosure. An example of which may include power sharing from a perspective of a wireless device, such as a phone.

The operations 1000 may begin, at block 1002, with receiving power from the first device at the second device. The operations 1000 may further include, at block 1004, receiving, at the second device, an indication from the first device that a third device may be connected with the first device. Further, the operations 1000 may include, at block 1006, transmitting, from the second device to the first device, a signal for adjusting at least one of a requested charging voltage and/or a requested charging current, based on the received indication.

In one or more cases, the second device may include a battery, and the operations 1000 further entail determining the at least one of the requested charging voltage or the requested charging current based on a parameter associated with the battery and on the received indication. The parameter may include a state of charge of the battery. According to one or more cases, the operations 1000 may further include receiving, at the second device, a signal indicating a parameter of the third device and determining the at least one of the requested charging voltage and/or the requested charging current based on the parameter of the third device. The parameter of the third device may include a type of the third device.

According to one or more aspects, the receiving the indication at block 1004 may further include receiving the indication via a pin designated for a configuration channel. The second device may include a universal serial bus (USB) type-C port comprising the pin designated for the configuration channel. The configuration channel may be a universal serial bus (USB) power delivery (PD) configuration channel 1 (CC1) or configuration channel 2 (CC2).

For example, an alert indicating power sharing when multiple Type-C ports on a source are used may be provided. Further, power levels change when loads on both ports exist which may also be alerted and adjusted in one or more examples. Further, one or more cases may include identifying what else may be connected to the various Type C ports in order to make an intelligent decision on power arbitration based on factors such as, but not limited to, state of charge (SOC), battery type, battery capacity, device type, and other parameters.

FIG. 10A is a block diagram of a device 1000A that may include various means-plus-function components configured to perform the operations 1000 illustrated in FIG. 10. For example, at block 1002A, the device 1000A includes means for performing the operations illustrated at block 1002 in FIG. 10. Additionally, at block 1004A, the device 1000A includes means for performing the operations illustrated at block 1004 in FIG. 10. For example, means for performing the operations as illustrated at blocks 1002 and 1004 of FIG. 10 may include a wireless device 202 as shown in FIG. 2. Further, the means for performing the operations may specifically include one or more of a temperature sensor 208, a battery 208, a charging port 210, a microprocessor 212, a communication module 218, and a memory 214.

### Example Charging Cable Resistance Determination

Power may be routed between electronic devices using different types of cables. As electric current flows through a cable, intrinsic resistance of the cable may cause voltage drops between different terminals of the cable. The voltage drop for high quality cables may be less than the voltage drop for low quality cables. In addition, in one or more cases, further impedance losses may be present due to traces and the existence of more components in this power path.

One common use of a cable may be to charge an electronic device's battery. In this application, a wall adapter receives AC voltage from a wall outlet and converts the AC voltage to a DC voltage. Current and voltage from the wall adapter (also referred to as a dedicated charge port or “DCP”) may be coupled through a cable to an electronic device, such as a cellular phone, to provide power to the device and/or charge the device's battery.

One issue associated with coupling power through a cable to an electronic device may be that different types of cables may result in different voltages being available at inputs of the electronic device circuitry. As current flows through a low quality cable, the voltage provided at the output of the wall adapter may drop significantly due to cable resistance by the time the current reaches the input of the electronic device. Yet, for high quality cables, there may be little resistive drop. Accordingly, some sensitive device circuitry may not operate properly due to voltage variations caused by different cable resistances. Accordingly, one or more examples are provided herewith that use the USB PD and communication and data available from both the charger and the charging device to help determine the cable resistance. Accordingly, this cable resistance may then be accounted for when providing power to the charging device.

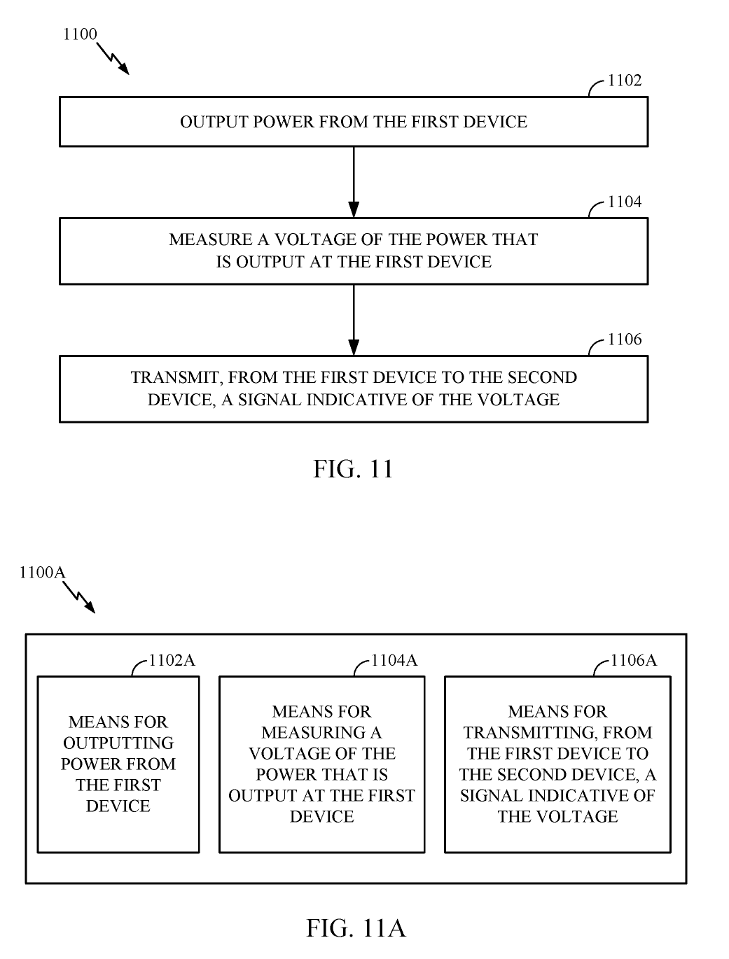

FIG. 11 is a flow diagram of example operations 1100 for providing power from a first device to a second device, the second device being configured for electrical connection with the first device via a cable, in accordance with certain aspects of the present disclosure, in accordance with certain aspects of the present disclosure. An example of which may include cable resistance measurement from the perspective of an adapter.

The operations 1100 may begin, at block 1102, with outputting power from the first device. The operations 1100 may further include, at block 1104, measuring a voltage of the outputted power at the first device. Further, the operations 1100 may include, at block 1106, transmitting, from the first device to the second device, a signal indicative of the measured voltage.

In one or more cases, the operations 1100 may further include transmitting the measured voltage under different editions and/or co-editions. According to one or more aspects, the transmitting may include transmitting the signal via a pin designated for a configuration channel. In one or more cases, the first device may include a universal serial bus (USB) type-C port comprising the pin designated for the configuration channel. The configuration channel may be a universal serial bus (USB) power delivery (PD) configuration channel 1 (CC1) or configuration channel 2 (CC2). The first device may be or include a power adapter. The first device may include an analog-to-digital converter (ADC), wherein measuring the voltage of the outputted power comprises using the ADC, and wherein the signal indicative of the measured voltage may be based on an output of the ADC.

FIG. 11A is a block diagram of a device 1100A that may include various means-plus-function components configured to perform the operations 1100 illustrated in FIG. 11. For example, at block 1102A, the device 1100A includes means for performing the operations illustrated at block 1102 in FIG. 11. Additionally, at block 1104A, the device 1100A includes means for performing the operations illustrated at block 1104 in FIG. 11. For example, means for performing the operations as illustrated at blocks 1102 and 1104 of FIG. 11 may include a charger device 204 as shown in FIG. 2. Further, the means for performing the operations may specifically include one or more of a temperature sensor 282, a logic component 228, a memory 226, and a signal transmitter/receiver 224.

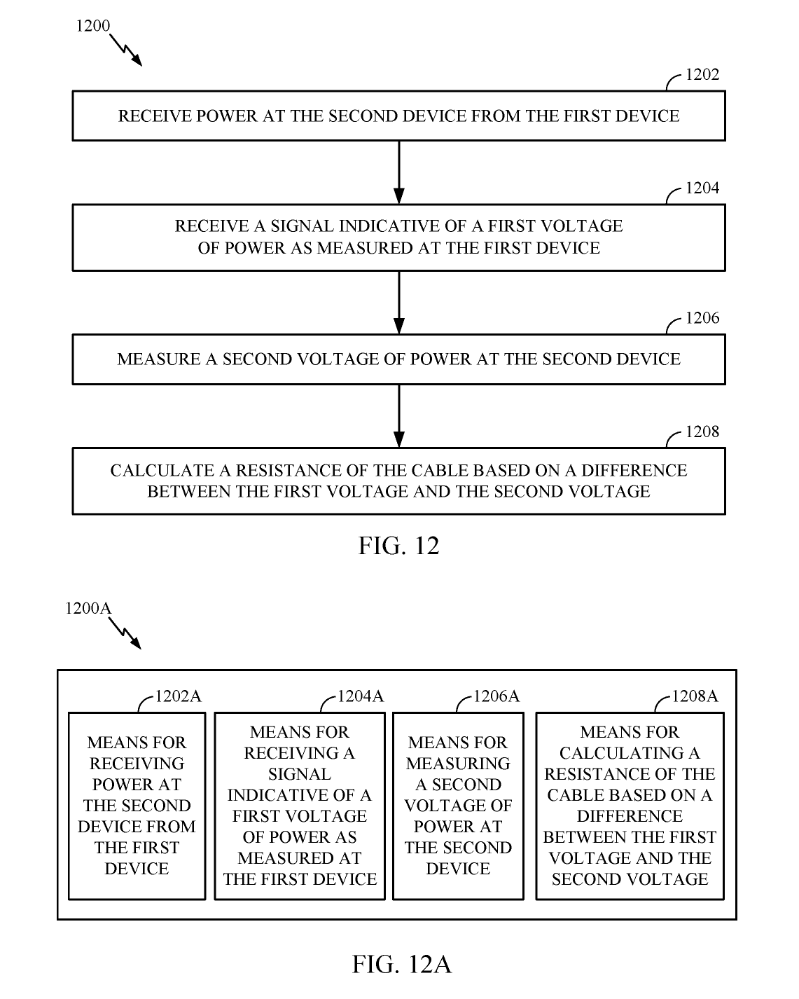

FIG. 12 is a flow diagram of example operations 1200 for receiving power from a first device at a second device, the second device being configured for electrical connection with the first device via a cable, in accordance with certain aspects of the present disclosure. An example of which may include cable resistance measurement from the perspective of a wireless device, such as a phone.

The operations 1200 may begin, at block 1202, with receiving power at the second device from the first device. The operations 1200 may further include, at block 1204, receiving a signal indicative of a first voltage of the power as measured at the first device. The operations 1200 further include, at block 1206, measuring a second voltage of the power at the second device. The operations 1200 may include, at block 1208, calculating a resistance of the cable based on the difference between the first voltage and the second voltage. In accordance with one or more cases, the time interval and/or conditions under which the second voltage is measured may vary and be configurable. In one or more cases, calculation of the cable resistance may involve also taking into account the load (current) during the two voltage measurements.

In accordance with one or more cases, the operations 1200 may further include determining a current associated with the power, wherein the calculating at block 1208 entails dividing the difference between the first and second voltages by the current. The receiving of the signal at block 1204 may further include receiving the signal via a pin designated for a configuration channel. In one or more cases, the second device may include a universal serial bus (USB) type-C port comprising the pin designated for the configuration channel. The configuration channel may be a universal serial bus (USB) power delivery (PD) configuration channel 1 (CC1) or configuration channel 2 (CC2). In one or more cases, the operations 1200 may further include implementing one or more actions from a group consisting of, but not limited to, reducing power, generating a UI indication, and stopping power transfer based on the calculated resistance.

According to one or more cases, the operations 1200 may further include taking an action at the second device, based on the calculated resistance of the cable. The action may include providing a notification at a user interface of the second device. The action may include transmitting a control signal from the second device to the first device. The control signal may include a shutdown signal for shutting down the first device. The control signal may include a power configuration signal for reducing at least one of a voltage or a current requested by the second device.

For example, according to one or more cases, a way to measure and detect cable resistance may be implemented as discussed above by having a voltage ADC on the adapter's output (using PD) and one in the phone measuring the input voltage. This information may be used to infer how hot the cable may be getting during charging by seeing how much the resistance increases as temperature on the connectors increases.

FIG. 12A is a block diagram of a device 1200A that may include various means-plus-function components configured to perform the operations 1200 illustrated in FIG. 12. For example, at block 1202A, the device 1200A includes means for performing the operations illustrated at block 1202 in FIG. 12. Additionally, at block 1204A, the device 1200A includes means for performing the operations illustrated at block 1204 in FIG. 12. Further, at block 1206A, the device 1200A includes means for performing the operations illustrated at block 1206 in FIG. 12. At block 1208A, the device 1200A includes means for performing the operations illustrated at block 1208 in FIG. 12. For example, means for performing the operations as illustrated at blocks 1202, 1204, 1206, and 1208 of FIG. 12 may include a wireless device 202 as shown in FIG. 2. Further, the means for performing the operations may specifically include one or more of a temperature sensor 208, a battery 208, a charging port 210, a microprocessor 212, a communication module 218, and a memory 214.

In one or more cases, a method using USB PD communication may be provided that may implement INOV technology to reduce charger IC power dissipation and reduce charge time. An example of INOV technology is described in U.S. patent application Ser. No. 14/856,947, filed on Sep. 17, 2015 and entitled “Systems and Methods for Charging a Battery,” herein incorporated by reference in its entirety. Another example of INOV technology is also described in PCT Application No. PCT/US2016/049130, filed on Aug. 26, 2016 and entitled “Systems and Methods for Charging a Battery,” herein incorporated by reference in its entirety.

In one or more cases, a charging device may be a power adapter. In other cases the charging device may be another device that may be able to provide power to the device being charged, such as a computer or another portable device.

In one or more cases, the charging device and device to be charged may be able to operate anywhere in a voltage range of, for example, 3 V to 21 V, with a step size of 20 mV. It is to be understood that other voltage ranges may be used and that the step size may be greater or smaller than 20 mV. Further, the charging device and device to be charged may be able to operate anywhere in a current range of, for example, 0 A to 5 A.

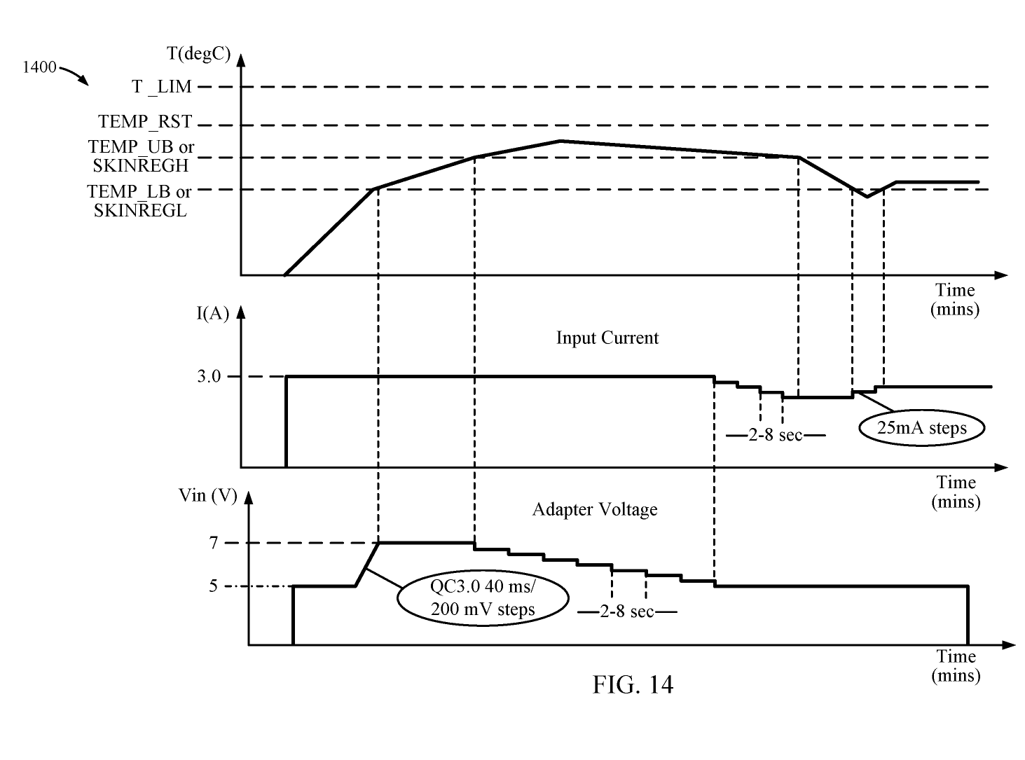

FIG. 14 is a diagram 1400 of charging shown over time based on temperature monitoring, in accordance with certain aspects of the present disclosure. As portrayed in an upper portion of the diagram 1400, a graph is depicted that compares temperature thresholds over time in minutes. Specifically, T_LIM (the temperature limit), TEMP_RST, TEMP_UB (or SKINREGH), and TEMP_LB (or SKINREGL) temperature thresholds are illustrated and indicated along the temperature axis (vertical axis). As portrayed, a temperature value over time is shown to initially rise up to TEMP_LB (a relatively lower bound for the temperature, also referred to as low skin regulation temperature (SKINREGL)). The temperature continues to rise with a different slope until the temperature reaches TEMP_UB (a relatively upper bound for the temperature, also referred to as high skin regulation temperature (SKINREGH)). The temperature then continues to rise and then fall without reaching TEMP_RST (a device reset bound for the temperature). The temperature is then shown dropping with another slope down below both TEMP_UB and TEMP_LB. Then finally the temperature is shown increasing again above TEMP_LB and then stabilizing for the remaining shown portion of temperature monitoring.

In the middle section of the diagram 1400 in FIG. 14 is shown the input current tracked over time for the same interval. As illustrated, the current remains at 3 A for a majority of the shown temperature monitoring time. At one point the current is lowered in 25 mA steps that are 2 seconds in length. Specifically, the current is shown going down by four steps and then maintaining that current for a period until the current is increased twice by similar 25 mA and 2 seconds in length steps.

Further, in the lower portion of the diagram 1400 in FIG. 14, the adapter voltage is shown over time for the same interval. As shown, the adapter voltage initially starts at zero and is raised to 5 V. The voltage is then raised again to 7 V. This step up from 5 V to 7 V is done with a 40 ms, 200 mV step as shown. The voltage tracking goes on to show the voltage being stepped down repeatedly using 2 second long steps back down to 5 V, which is then maintained for the remainder of the time shown. FIG. 14 indicates using dotted lines where the voltage and current adjustments occurred in time in relation to the temperature value as compared to the thresholds shown.

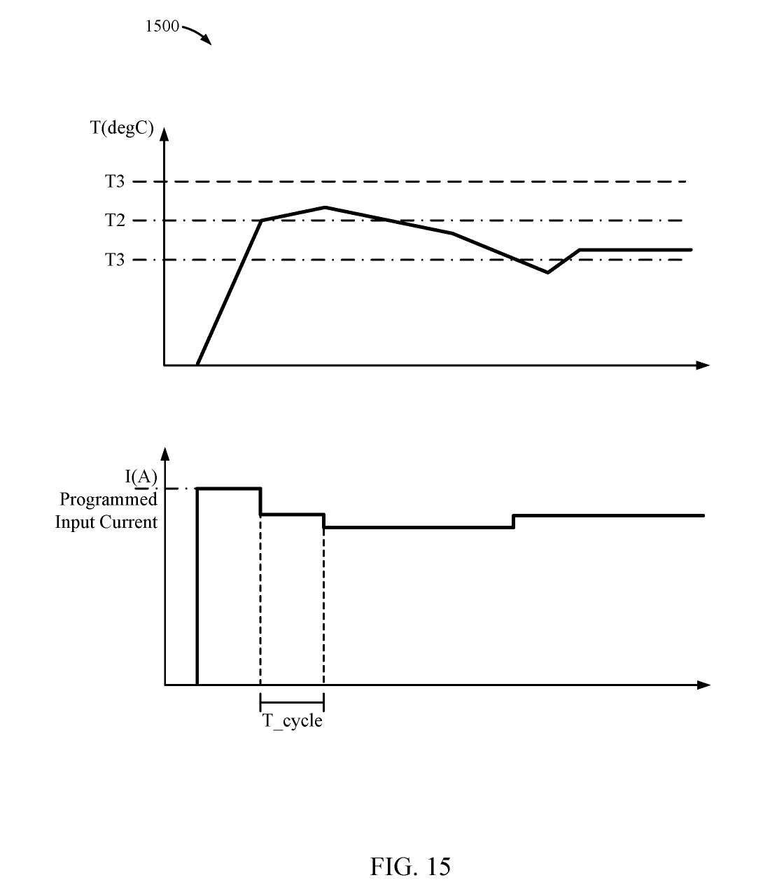

FIG. 15 is a diagram 1500 of charging shown over time based on temperature monitoring of a USB connector, in accordance with certain aspects of the present disclosure.

In this example, as shown in an upper portion of FIG. 15, a temperature value is tracked over time and compared against three thresholds labeled “T1,” “T2,” and “T3.” In a lower portion of FIG. 15, a programmed input current is shown over time for the same interval. As shown, the current is adjusted using T_cycle length steps. As shown the current is lowered which provides a lowering of tracked temperatures and toward the end may be increased, resulting in an increase of temperature.

In one or more cases, a power source may be a battery bank and/or a phone application where someone may be charging a device connected to one of these. In the battery bank or phone, an IC may monitor the connector and die temperature inside of the bank/phone during power output and issue messages over the CC line with USB PD.

According to one or more cases, the device being charged or the charger may be configured to take an ADC measurement of the current also in order to calculate the resistance. An example ADC measurement is described in U.S. patent application Ser. No. 14/303,883, filed Jun. 13, 2014 and entitled “Systems and Methods for Cable Resistance Compensation,” herein incorporated by reference in its entirety. Additionally, example ADC measurement is described in PCT Application No. PCT/US2015/032721, filed May 27, 2015 and entitled “Systems and Methods for Cable Resistance Compensation,” herein incorporated by reference in its entirety.

In accordance with one or more cases, once a power source transmits temperature information to a sink (a phone for example), the sink can correspondingly reduce the phone's power intake before the source enters a fault condition, which may provide a safer and more fluid user experience. An additional feature that may be provided includes notifying the user visually in software about this event.

According to certain aspects, a method for providing power from a first device to a second device is provided, the second device being configured for electrical connection with the first device via a cable may be provided. The method may include receiving a signal at the first device via a pin designated for a configuration channel, the signal indicating at least one of a requested charging voltage or a requested charging current, and outputting power from the first device to the second device based on the signal.

In some cases, the first device may include a universal serial bus (USB) type-C port including the pin designated for the configuration channel. The configuration channel may be a universal serial bus (USB) power delivery (PD) configuration channel 1 (CC1) or configuration channel 2 (CC2). The first device may include a power adapter.

According to certain aspects, a method for receiving power from a first device at a second device, the second device being configured for electrical connection with the first device via a cable may be provided. The method may include transmitting a signal from the second device to the first device via a pin designated for a configuration channel, the signal indicating at least one of a requested charging voltage or a requested charging current, and receiving power from the first device at the second device based on the at least one of the requested charging voltage or the requested charging current.

In some cases, the second device includes a universal serial bus (USB) type-C port including the pin designated for the configuration channel. In some cases, the configuration channel is a universal serial bus (USB) power delivery (PD) configuration channel 1 (CC1) or configuration channel 2 (CC2). In some cases, the method further includes determining the at least one of the requested charging voltage or the requested charging current based on one or more parameters associated with at least one of the first device or the second device. In some cases, the second device includes a battery and wherein the one or more parameters include a state of charge of the battery. In some cases, the one or more parameters include at least one of one or more thermal signals associated with the first device, a load on the first device, or a charge power for the second device. In some cases, the determining includes determining the requested charging voltage with a resolution of 20 mV or less.

According to certain aspects, a method for providing power from a first device to a second device, the second device being configured for electrical connection with the first device via a cable may be provided. The method may include sensing a temperature associated with the first device, determining that the temperature is above a threshold, and transmitting a signal from the first device to the second device based on determining that the temperature is above the threshold.

In some cases, the method further includes outputting power from the first device, wherein the temperature is sensed while the first device is outputting the power. In some cases, the transmitting includes transmitting the signal via a pin designated for a configuration channel. In some cases, the first device includes a universal serial bus (USB) type-C port including the pin designated for the configuration channel. In some cases, the configuration channel is a universal serial bus (USB) power delivery (PD) configuration channel 1 (CC1) or configuration channel 2 (CC2). In some cases, the signal includes at least one of a warning flag, a shutdown flag, or a thermal regulation flag. In some cases, the first device includes a housing, and wherein the temperature associated with the first device includes a housing temperature of the housing. In some cases, the first device includes an interface for connecting the cable, and wherein the temperature associated with the first device includes an interface temperature of the interface. In some cases, the temperature associated with the first device includes an ambient temperature adjacent the first device. In some cases, the method further includes sensing another temperature associated with the first device, determining that the other temperature is above another threshold, and transmitting another signal from the first device to the second device based on determining that the other temperature is above the other threshold. In some cases, the first device includes a power adapter.

According to certain aspects, a method for receiving power from a first device at a second device, the second device being configured for electrical connection with the first device via a cable, may be provided. The method may include receiving an alert signal at the second device from the first device, the alert signal being based on a temperature associated with the first device being above a threshold, and taking an action at the second device, based on the alert signal.

In some cases, the method further includes receiving power at the second device from the first device, wherein the alert signal is received while the second device is receiving power from the first device. In some cases, the action includes providing a notification at a user interface of the second device. In some cases, the action includes transmitting a control signal from the second device to the first device. In some cases, the control signal includes a shutdown signal for shutting down the first device. In some cases, the control signal includes a power configuration signal for reducing at least one of a voltage or a current requested by the second device. In some cases, the transmitting includes transmitting the control signal via a pin designated for a configuration channel. In some cases, the first device includes a universal serial bus (USB) type-C port including the pin designated for the configuration channel. In some cases, the configuration channel is a universal serial bus (USB) power delivery (PD) configuration channel 1 (CC1) or configuration channel 2 (CC2). In some cases, the alert signal includes at least one of a warning flag, a shutdown flag, or a thermal regulation flag.

According to certain aspects, a method for providing power from a first device to a second device, the second device being configured for electrical connection with the first device via a cable, may be provided. The method may include receiving a query at the first device from the second device whether the first device is configured to support dynamic adjustment of a charging voltage with a resolution of 20 mV or smaller, and transmitting a response from the first device to the second device, in response to the query.

In some cases, the query includes a vendor-defined message (VDM). In some cases, the receiving includes receiving the query via a pin designated for a configuration channel. In some cases, the first device includes a universal serial bus (USB) type-C port including the pin designated for the configuration channel. In some cases, the configuration channel is a universal serial bus (USB) power delivery (PD) configuration channel 1 (CC1) or configuration channel 2 (CC2). In some cases, the query is configured to query whether the first device is configured to support dynamic power adjustment in compliance with a universal serial bus (USB) power delivery (PD) standard. In some cases, the query is further configured to query whether the first device is configured to support at least one of one or more thermal monitors or one or more particular power profiles. In some cases, the first device includes a power adapter.

According to certain aspects, a method for receiving power from a first device at a second device, the second device being configured for electrical connection with the first device via a cable, may be provided. The method may include transmitting, from the second device to the first device, a query whether the first device is configured to support dynamic adjustment of a charging voltage with a resolution of 20 mV or smaller, receiving, at the second device, a response from the first device in response to the query.

In some cases, the method further includes transmitting a signal from the second device to the first device, wherein the transmitted signal indicates at least one of a requested charging voltage or a requested charging current, and receiving power from the first device at the second device based on the at least one of the requested charging voltage or the requested charging current.

In some cases, the query includes a vendor-defined message (VDM). In some cases, the transmitting includes transmitting the query via a pin designated for a configuration channel. In some cases, the second device includes a universal serial bus (USB) type-C port including the pin designated for the configuration channel. In some cases, the configuration channel is a universal serial bus (USB) power delivery (PD) configuration channel 1 (CC1) or configuration channel 2 (CC2). In some cases, the query is configured to query whether the first device is configured to support dynamic power adjustment in compliance with a universal serial bus (USB) power delivery (PD) standard.

According to certain aspects, a method for receiving power from a first device at a second device, the second device being configured for electrical connection with the first device via a cable may be provided. The method may include receiving power from the first device at the second device; receiving, at the second device, an indication from the first device that a third device is connected with the first device; and transmitting, from the second device to the first device, a signal for adjusting at least one of a requested charging voltage or a requested charging current, based on the indication.

In some cases, the second device includes a battery and wherein the method further includes determining the at least one of the requested charging voltage or the requested charging current based on a parameter associated with the battery and on the indication. In some cases, the parameter includes a state of charge of the battery. In some cases, the method further includes receiving, at the second device, a signal indicating a parameter of the third device, wherein the method further includes determining the at least one of the requested charging voltage or the requested charging current based on the parameter of the third device. In some cases, the parameter of the third device includes a type of the third device. In some cases, the receiving the indication includes receiving the indication via a pin designated for a configuration channel. In some cases, the second device includes a universal serial bus (USB) type-C port including the pin designated for the configuration channel. In some cases, the configuration channel is a universal serial bus (USB) power delivery (PD) configuration channel 1 (CC1) or configuration channel 2 (CC2).

According to certain aspects, a method for providing power from a first device to a second device, the second device being configured for electrical connection with the first device via a cable, may be provided. The method may include outputting power from the first device, measuring a voltage of the power that is output at the first device, and transmitting, from the first device to the second device, a signal indicative of the voltage.

In some cases, the transmitting includes transmitting the signal via a pin designated for a configuration channel. In some cases, the first device includes a universal serial bus (USB) type-C port including the pin designated for the configuration channel. In some cases, the configuration channel is a universal serial bus (USB) power delivery (PD) configuration channel 1 (CC1) or configuration channel 2 (CC2). In some cases, the first device includes a power adapter. In some cases, the first device includes an analog-to-digital converter (ADC), wherein measuring the voltage of the power that is output includes using the ADC, and wherein the signal indicative of the voltage is based on an output of the ADC.

According to certain aspects, a method for receiving power from a first device at a second device, the second device being configured for electrical connection with the first device via a cable, may be provided. The method may include receiving power at the second device from the first device, receiving a signal indicative of a first voltage of power as measured at the first device, measuring a second voltage of power at the second device, and calculating a resistance of the cable based on a difference between the first voltage and the second voltage.

In some cases, the method, further includes determining a current associated with power, wherein the calculating the resistance includes dividing the difference between the first voltage and the second voltage by the current. In some cases, the receiving the signal includes receiving the signal via a pin designated for a configuration channel. In some cases, the second device includes a universal serial bus (USB) type-C port including the pin designated for the configuration channel. In some cases, the configuration channel is a universal serial bus (USB) power delivery (PD) configuration channel 1 (CC1) or configuration channel 2 (CC2). In some cases, the method further includes taking an action at the second device, based on the resistance of the cable. In some cases, the action includes providing a notification at a user interface of the second device. In some cases, the action includes transmitting a control signal from the second device to the first device. In some cases, the control signal includes a shutdown signal for shutting down the first device. In some cases, the control signal includes a power configuration signal for reducing at least one of a voltage or a current requested by the second device.

The methods described herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The various illustrative logical blocks, modules, and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods described herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a charging device or a device to be charged. The processing system may be implemented with bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the physical (PHY) layer. In the case of a user terminal, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processing system may be configured as a general-purpose processing system with one or more microprocessors providing the processor functionality and external memory providing at least a portion of the machine-readable media, all linked together with other supporting circuitry through external bus architecture. Alternatively, the processing system may be implemented with an ASIC with the processor, the bus interface, the user interface in the case of an access terminal), supporting circuitry, and at least a portion of the machine-readable media integrated into a single chip, or with one or more FPGAs, PLDs, controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for providing power from a first device to a second device, the second device being configured for electrical connection with the first device via a cable, the method comprising:
transmitting a signal comprising one or more parameters associated with the first device to the second device;
receiving a signal at the first device via a pin designated for a configuration channel, the signal indicating at least one of a requested charging voltage or a requested charging current based on the one or more parameters; and
outputting power from the first device to the second device based on the signal.

2. The method of claim 1, wherein the first device comprises a universal serial bus (USB) type-C port comprising the pin designated for the configuration channel.

3. The method of claim 1, wherein the configuration channel is a universal serial bus (USB) power delivery (PD) configuration channel 1 (CC1) or configuration channel 2 (CC2).

4. The method of claim 1, wherein the first device comprises a power adapter.

5. A method for receiving power from a first device at a second device, the second device being configured for electrical connection with the first device via a cable, the method comprising:
receiving a signal comprising one or more parameters associated with the first device at the second device;
transmitting a signal from the second device to the first device via a pin designated for a configuration channel, the signal indicating at least one of a requested charging voltage or a requested charging current based on the one or more parameters; and
receiving power from the first device at the second device based on the at least one of the requested charging voltage or the requested charging current.

6. The method of claim 5, wherein the second device comprises a universal serial bus (USB) type-C port comprising the pin designated for the configuration channel.

7. The method of claim 5, wherein the configuration channel is a universal serial bus (USB) power delivery (PD) configuration channel 1 (CC1) or configuration channel 2 (CC2).

8. The method of claim 5, wherein the at least one of the requested charging voltage or the requested charging current is further based on one or more parameters associated with the second device.

9. The method of claim 8, wherein the second device comprises a battery and wherein the one or more parameters associated with the second device comprise a state of charge of the battery.

10. The method of claim 8, wherein the one or more parameters associated with the first device comprise at least one of one or more thermal signals associated with the first device, a load on the first device, or a charge power for the first device.

11. The method of claim 8, wherein the determining comprises determining the requested charging voltage with a resolution of 20 mV or less.

12. The method of claim 8, wherein the determining comprises determining the requested charging current with a resolution of 100 mA or less.

13. A first device for providing power to a second device, the first device being configured for electrical connection with the second device via a cable, the first device comprising:
at least one logic circuit configured to:
transmit a signal comprising one or more parameters associated with the first device to the second device; and
receive a signal via a pin designated for a configuration channel, the signal indicating at least one of a requested charging voltage or a requested charging current based on the one or more parameters; and
a power supply configured to output power from the first device to the second device based on the signal.

14. The first device of claim 13, further comprising a universal serial bus (USB) type-C port comprising the pin designated for the configuration channel.

15. The first device of claim 13, wherein the configuration channel is a universal serial bus (USB) power delivery (PD) configuration channel 1 (CC1) or configuration channel 2 (CC2).

16. The first device of claim 13, wherein the first device is a power adapter.

17. A first device capable of electrical connection with a second device via a cable, the first device comprising:
at least one logic circuit configured to:
receive a signal comprising one or more parameters associated with the second device;
transmit a signal to the second device via a pin designated for a configuration channel, the signal indicating at least one of a requested charging voltage or a requested charging current based on the one or more parameters; and
a charging port configured to receive power from the second device based on the at least one of the requested charging voltage or the requested charging current.

18. The first device of claim 17, wherein the charging port is a universal serial bus (USB) type-C port comprising the pin designated for the configuration channel.

19. The first device of claim 17, wherein the configuration channel is a universal serial bus (USB) power delivery (PD) configuration channel 1 (CC1) or configuration channel 2 (CC2).

20. The first device of claim 17, wherein the at least one of the requested charging voltage or the requested charging current is further based on one or more parameters associated with at least one of the first device

21. The first device of claim 20, comprising a battery, wherein the one or more parameters comprise a state of charge of the battery.

22. The first device of claim 20, wherein the one or more parameters associated with the second device comprise at least one of one or more thermal signals associated with the second device, a load on the second device, or a charge power for the second device.

23. The first device of claim 20, wherein the first device is further configured to determine the requested charging voltage with a resolution of 20 mV or less.

24. The first device of claim 20, wherein the first device is further configured to determine the requested charging current with a resolution of 100 mA or less.
